(19) United States
(12) Patent Application Publication
(10) Pub. No.: US 2011/0143923 A1
(43) Pub. Date: Jun. 16, 2011

(54) TITANIUM DIOXIDE COMPOSITION COMPRISING TITANIUM DIOXIDE NANOPARTICLES, AND PREPARATION AND USE THEREOF

(75) Inventors: Virginie Bette, Mannheim (DE); Roelof Balk, Boehl-Iggelheim (DE); Alexandre Terrenoire, Mannheim (DE); Harm Wiese, Laudenbach (DE); Ekkehard Jahns, Weinheim (DE); Matthias Ballauff, Potsdam (DE); Yan Lu, Berlin (DE); Martin Hoffmann, Berlin (DE)

(73) Assignee: BASF SE, Ludwigshafen (DE)

(21) Appl. No.: 12/996,306

(22) PCT Filed: Jun. 2, 2009
(86) PCT No.: PCT/EP09/56724

§ 371 Date: Feb. 23, 2011

(30) Foreign Application Priority Data
Jun. 3, 2008 (EP) 08157495.6

(51) Int. Cl. B01J 37/08; B01J 37/00; C01G 23/08; B01J 31/06; B01J 21/18; B05D 3/02; B32B 27/18; B82Y 30/00

(52) U.S. Cl. 502/159; 502/182; 423/610; 427/372.2; 428/461; 428/513; 977/773; 977/775

(57) ABSTRACT

The present invention relates to a titanium dioxide composition which comprises titanium dioxide nanoparticles, its preparation and use.

The present invention relates to a titanium dioxide composition which comprises titanium dioxide nanoparticles, its preparation and use.

In the past decades, titanium dioxide nanomaterials (TiO₂ nanomaterials) have been intensively researched. This led to numerous promising applications in the fields of photocatalysis and sensorics. The titanium dioxide nanomaterials are used here, for example, in the form of nanoparticles, nanocylinders, nanotubes and nanowires. Besides a high chemical stability and low toxicity, TiO₂ nanomaterials of this type generally also have further special properties, such as photocatalytic activity, or the ability to be used in photovoltaics. Photocatalysis with TiO₂ is also considered to be a potentially promising method for the destruction and removal of organic constituents, for example for maintaining air quality, and the inactivation of microorganisms. There is therefore a need for effective synthesis processes for TiO₂ nanomaterials and also for novel TiO₂ nanomaterials with a favorable profile of properties for one or more of the aforementioned or still-to-be-disclosed fields of use.

Several processes are known for the synthesis of TiO₂ nanomaterials. These include the hydrothermal process, chemical deposition from the gas phase, deposition from the liquid phase and sol-gel processes by hydrolysis of titanium alkoxides. The nanocrystals produced in this way, however, often have a nonuniform shape and a broad size distribution. For example, spherical colloid particles of TiO₂ with diameters between 100 nm and several micrometers are obtained according to the sol-gel process.

WO 2005/100459 describes a coating material with a binder and a filler which has particles with a size of less than 10 μm and/or a surface roughness of less than 10 μm, and also the use of such a coating material for coating facades and other sections of building structures. The binder preferably comprises a photocatalytically active metal oxide, such as titanium dioxide.

DE 10 2005 057 747 A1 describes a composition for coating walls, building covers, facades, highways, footpaths, public places, roofing slabs, roof claddings etc. This has a binder with a photocatalytically active agent with a significant photoabsorption at an absorption wavelength in the range between 380 and 500 nm. Preference is given to binders based on silicate nanocomposites which have a TiO₂ semiconductor as photocatalytically active agent. Amorphous, partially crystalline or crystalline titanium oxide or hydrous titanium oxide or a titanium hydrate or a titanium oxyhydrate can be used for producing the photocatalytically active compound. Additionally, a modification with a thermally decomposable carbon compound can take place. The production of the photocatalytically active agents generally involves a final calcination.

EP 1 512 728 A1 describes photocatalytic coating compositions, composite materials and processes for their preparation. The photocatalytic coating composition comprises: (a) photocatalytically active oxide particles, (b) an emulsion of a hydrophobic resin and (c) water. They serve for producing self-cleaning external paints. Titanium dioxide particles are used inter alia as photocatalyst.

WO 2006/048167 describes an aqueous coating mass which comprises a) particles with an average particle size of >10 nm and <500 nm, which are composed of a polymer and a finely divided inorganic solid (composite particles), and b) at least one pulverulent pigment selected from zinc oxide, zinc sulfide, iron(III) oxide, tin dioxide, and titanium dioxide in the rutile, anatase or Brookite modification.

X. Guo, A. Weiss and M. Ballauff describe in Macromolecules 1999, 32, pp. 6043-6046 the synthesis of polymer particles with a hydrophobic core and polyelectrolyte side chains bonded thereto, so-called spherical polyelectrolyte brushes (SPB). X. Guo and M. Ballauff describe in Langmuir 2000, 16, pp. 8719-8726 spatial dimensions of SPB, determined by dynamic light scattering. In Prog. Polym. Sci. 32 (2007), pp. 1135-1151, M. Ballauff gives an overview of SPB, processes for their preparation and their characteristic properties.

Y. Lu, Y. Mei, M. Shrinner, M. Ballauff, M. W. Möller and J. Breu describe in J. Phys. Chem C 2007, 111, pp. 7676-7681 the in-situ formation of Ag nanoparticles in spherical polyacrylic acid brushes as template by UV irradiation.

There is still a need for processes for the synthesis of colloidally stable titanium dioxide nanoparticles, specifically with particle sizes of at most 20 nm and/or a narrow particle size distribution. Furthermore, there is also still a need for a process for the synthesis of titanium dioxide nanoparticles which have a degree of crystallinity and a crystal modification which are optimized with regard to photocatalytic activity. In this connection, especially mesoporous TiO₂ networks with the largest possible surface area are of particular interest. There is a specific need for titanium dioxide-containing materials which comprise highly crystalline, mesoporous TiO₂ and for a synthesis of such materials which permits the most complete retention possible of the mesostructure.

Surprisingly, it has now been found that the synthesis of well defined and crystalline TiO₂ nanoparticles takes place even at room temperature in the presence of spherical polyelectrolyte brushes. The resulting titanium dioxide nanoparticles and the materials comprising these are highly photocatalytically active. Furthermore, it has surprisingly been found that, through calcination of these particles under defined conditions, it is possible to obtain stable, mesoporous titanium dioxide-containing materials.

The invention therefore firstly provides a process for the preparation of a titanium dioxide composition which comprises titanium dioxide nanoparticles, in which a hydrolyzable titanium compound is subjected to a hydrolysis in the presence of polymer particles with a hydrophobic core and polyelectrolyte side chains bonded thereto.

The invention further provides a titanium dioxide composite composition which comprises TiO₂ nanoparticles which are associated with such SPB polymer particles.

The invention further provides a titanium dioxide composition with a mesoporous and macroporous structure.

Within the context of the present application, nanoparticles (nanoscale particles) are understood as meaning particles with a volume-averaged particle diameter of at most 100 nm. A preferred particle size range is 3 to 50 nm, in particular 4 to 30 nm and particularly preferably 4 to 15 nm.

Within the context of the invention, the term composite composition refers to TiO₂ particles which are associated with polymer particles. Suitable polymer particles with a hydrophobic core and polyelectrolyte side chains bonded thereto are described in more detail below. In this connection, the composite composition can firstly be present in the form of a dispersion of composite particles as dispersed phase in a liquid medium as continuous phase. The composite composition can furthermore be present in solid form, e.g. in powder form. Solid composite compositions can be obtained by drying a dispersion of composite particles in accordance with customary methods known to the person skilled in the art. Solid composite compositions which have not been subjected to a calcination are generally redispersible. Thus, in a suitable embodiment for the preparation of coating compositions, the titanium dioxide composite compositions are used in the form of a dispersion in an aqueous medium.

Liquid titanium dioxide composite compositions can be obtained in the form of a stable dispersion (special suspension). In the suspension, the polymer particles form the disperse phase with TiO₂ nanoparticles associated thereto. Associated TiO₂ nanoparticles are understood as meaning that these are immobilized in the sphere of the polyelectrolyte side chains. Outside this sphere, the liquid titanium dioxide composite compositions according to the invention have essentially no free TiO₂.

Suitable hydrolyzable titanium compounds are tetraalkyl orthotitanates and tetraalkyl orthosilicates. Here, alkyl is preferably C₁-C₆-alkyl. Alkyl selected from methyl, ethyl, n-propyl or n-butyl is particularly preferred. The hydrolyzable titanium compounds used are preferably tetraalkyl orthotitanates. An especially suitable compound is tetraethyl orthotitanate (TEOT).

The polymer particles used according to the invention have a hydrophobic core and polyelectrolyte side chains bonded thereto. Polymer particles suitable for use in the process according to the invention which have a hydrophobic core and polyelectrolyte side chains bonded thereto are described by M. Ballauff in Prog. Polym. Sci. 32 (2007), pp. 1135-1151, to which reference is hereby made in its entirety.

These polymer particles can be obtained, for example, by, in a first stage, subjecting at least one hydrophobic α,β-ethylenically unsaturated monomer (M1) to a free-radical polymerization to give the polymer particles forming the core and then, in a second stage, grafting the polyelectrolyte side chains onto the polymer particles forming the core.

Preferably, the monomers (M1) are selected from vinyl aromatics, esters of α,β-ethylenically unsaturated mono- and dicarboxylic acids with C₁-C₂₀-alkanols, ethylenically unsaturated nitriles, esters of vinyl alcohol with C₁-C₃₀-monocarboxylic acids, vinyl halides, vinylidene halides, C₂-C₈-monoolefins, nonaromatic hydrocarbons with at least two conjugated double bonds and mixtures thereof.

Preferred vinyl aromatics (M1) are styrene, 2-methylstyrene, 4-methylstyrene, 2-(n-butyl)styrene, 4-(n-butyl)styrene, 4-(n-decyl)styrene and particularly preferably styrene.

Esters of α,β-ethylenically unsaturated mono- and dicarboxylic acids with C₁-C₂₀-alkanols suitable as monomer (M1) are methyl (meth)acrylate, methyl ethacrylate, ethyl (meth)acrylate, ethyl ethacrylate, n-propyl (meth)acrylate, isopropyl (meth)acrylate, n-butyl (meth)acrylate, sec-butyl (meth)acrylate, tert-butyl (meth)acrylate, tert-butyl ethacrylate, n-hexyl (meth)acrylate, n-heptyl (meth)acrylate, n-octyl (meth)acrylate, 1,1,3,3-tetramethylbutyl (meth)acrylate, ethylhexyl (meth)acrylate, n-nonyl (meth)acrylate, n-decyl (meth)acrylate, n-undecyl (meth)acrylate, tridecyl (meth)acrylate, myristyl (meth)acrylate, pentadecyl (meth)acrylate, palmityl (meth)acrylate, heptadecyl (meth)acrylate, nonadecyl (meth)acrylate, arachinyl (meth)acrylate, behenyl (meth)acrylate, lignoceryl (meth)acrylate, cerotinyl (meth)acrylate, melissinyl (meth)acrylate, palmitoleinyl (meth)acrylate, oleyl (meth)acrylate, linolyl (meth)acrylate, linolenyl (meth)acrylate, stearyl (meth)acrylate, lauryl (meth)acrylate and mixtures thereof.

Suitable esters of vinyl alcohol with C₁-C₃₀-monocarboxylic acids are, for example, vinyl formate, vinyl acetate, vinyl propionate, vinyl butyrate, vinyl laurate, vinyl stearate, vinyl propionate, versatic acid vinyl ester and mixtures thereof.

Suitable ethylenically unsaturated nitriles are acrylonitrile, methacrylonitrile and mixtures thereof.

Suitable vinyl halides and vinylidene halides are vinyl chloride, vinylidene chloride, vinyl fluoride, vinylidene fluoride and mixtures thereof.

Suitable C₂-C₈-monoolefins and nonaromatic hydrocarbons with at least conjugated double bonds are, for example, ethylene, propylene, isobutylene, isoprene, butadiene, etc.

Styrene or a styrene-containing monomer mixture is particularly preferably used as monomer (M1). In particular, styrene is used as the sole monomer for preparing the polymer particles forming the core (where additionally a surface modification of the styrene particles forming the core can take place to join the polyelectrolyte side chains, as described below).

In the preparation of the polymer particles forming the core, at least one crosslinker can be used in addition to the aforementioned monomers M1). Suitable monomers which have a crosslinking function are compounds with at least two polymerizable, ethylenically unsaturated, nonconjugated double bonds in the molecule.

Suitable crosslinkers are, for example, acrylic esters, methacrylic esters, allyl ethers or vinyl ethers of at least dihydric alcohols. The OH groups of the parent alcohols here may be completely or partially etherified or esterified; however, the crosslinkers comprise at least two ethylenically unsaturated groups. Examples of the parent alcohols are dihydric alcohols, such as 1,2-ethanediol, 1,2-propanediol, 1,3-propanediol, 1,2-butanediol, 1,3-butanediol, 2,3-butanediol, 1,4-butanediol, but-2-ene-1,4-diol, 1,2-pentanediol, 1,5-pentanediol, 1,2-hexanediol, 1,6-hexanediol, 1,10-decanediol, 1,2-dodecanediol, 1,12-dodecanediol, neopentyl glycol, diethylene glycol, triethylene glycol, tetraethylene glycol, dipropylene glycol, tripropylene glycol, tetrapropylene glycol, etc.

Further suitable crosslinkers are the vinyl esters or the esters of monohydric, unsaturated alcohols with ethylenically unsaturated C₃-C₆-carboxylic acids, for example acrylic acid, methacrylic acid, itaconic acid, maleic acid or fumaric acid. Examples of such alcohols are allyl alcohol, 1-buten-3-ol, 5-hexen-1-ol, 1-octen-3-ol, 9-decen-1-ol, dicyclopentenyl alcohol, 10-undecen-1-ol, cinnamyl alcohol, citronellol, crotyl alcohol or cis-9-octadecen-1-ol. The monohydric, unsaturated alcohols can also be esterified with polybasic carboxylic acids, for example malonic acid, tartaric acid, trimellitic acid, phthalic acid, terephthalic acid, citric acid or succinic acid.

Further suitable crosslinkers are esters of unsaturated carboxylic acids with the above-described polyhydric alcohols, for example oleic acid, crotonic acid, cinnamic acid or 10-undecenoic acid.

Suitable crosslinkers are furthermore straight-chain or branched, linear or cyclic, aliphatic or aromatic hydrocarbons which have at least two double bonds, which in the case of aliphatic hydrocarbons must not be conjugated, e.g. divinylbenzene, divinyltoluene, 1,7-octadiene, 1,9-decadiene, 4-vinyl-1-cyclohexene, trivinylcyclohexane, etc.

Also suitable as crosslinkers are the acrylamides, methacrylamides and N-allylamines of at least difunctional amines. Such amines are, for example, 1,2-diaminoethane, 1,3-diaminopropane, 1,4-diaminobutane, 1,6-diaminohexane, 1,12-dodecanediamine, piperazine, diethylenetriamine or isophoronediamine. Likewise suitable are the amides of allylamine and unsaturated carboxylic acids, such as acrylic acid, methacrylic acid, itaconic acid, maleic acid, or at least dibasic carboxylic acids, as have been described above.

Furthermore, triallylamine and triallylmonoalkylammonium salts, e.g. triallylmethylammonium chloride or methyl sulfate, are suitable as crosslinkers.

Suitable crosslinkers are also N-vinyl compounds of urea derivatives, at least difunctional amides, cyanurates or urethanes, for example of urea, ethyleneurea, propylene urea or tartardiamide, e.g. N,N′-divinylethyleneurea or N,N′-divinylpropylene-urea.

Further suitable crosslinkers are divinyldioxane, tetraallylsilane or tetravinylsilane. It is of course also possible to use mixtures of the abovementioned compounds. Preferably, water-soluble crosslinkers are used.

The crosslinker (if present) is used preferably in an amount of from 0.0005 to 5% by weight, preferably 0.001 to 2.5% by weight, in particular 0.01 to 1.5% by weight, based on the total weight of the monomers forming the core used for the polymerization.

In a specific embodiment, no crosslinker is used for producing the polymer particles forming the core.

Preferably, the polymerization takes place in the first stage in the form of an aqueous emulsion polymerization.

For the preparation of the polymer particles forming the core, the monomers can be polymerized with the help of initiators which form free radicals.

Initiators which can be used for the free-radical polymerization are the peroxo and/or azo compounds customary for this purpose, for example alkali metal or ammonium peroxydisulfates, diacetyl peroxide, dibenzoyl peroxide, succinyl peroxide, di-tert-butyl peroxide, tert-butyl perbenzoate, tert-butyl perpivalate, tert-butyl peroxy-2-ethylhexanoate, tert-butyl permaleate, cumene hydroperoxide, diisopropyl peroxydicarbamate, bis(o-toloyl) peroxide, didecanoyl peroxide, dioctanoyl peroxide, dilauroyl peroxide, tert-butyl perisobutyrate, tert-butyl peracetate, di-tert-amyl peroxide, tert-butyl hydroperoxide, azobisisobutyronitrile, 2,2′-azobis(2-amidinopropane) dihydrochloride or 2,2′-azobis(2-methylbutyronitrile). Mixtures of these initiators are also suitable. Initiators which can be used are also customary reducing/oxidizing (=red/ox) initiator systems. Preferred initiators are alkali metal peroxydisulfates, specifically potassium peroxodisulfate.

The amount of initiators is generally 0.1 to 10% by weight, preferably 0.1 to 5% by weight, based on all of the monomers to be polymerized. Two or more different initiators may also be used in the emulsion polymerization.

The preparation of the polymer particles forming the core usually takes place in the presence of at least one interface-active compound. A detailed description of suitable protective colloids can be found in Houben-Weyl, Methoden der organischen Chemie [Methods of organic chemistry], volume XIV/1, Makromolekulare Stoffe [macromolecular substances], Georg Thieme Verlag, Stuttgart, 1961, pp. 411-420. Suitable emulsifiers can also be found in Houben-Weyl, Methoden der organischen Chemie [Methods of organic chemistry], volume 14/1, Makromolekulare Stoffe [macromolecular substances], Georg Thieme Verlag, Stuttgart, 1961, pp. 192-208. Suitable emulsifiers are anionic, cationic or nonionic emulsifiers. Preferably, the interface-active substances used are emulsifiers whose relative molecular weights are usually below those of protective colloids.

Suitable anionic emulsifiers are, for example, alkali metal and ammonium salts of alkyl sulfates (alkyl radical: C₈-C₂₂), of sulfuric acid half-esters of ethoxylated alkanols (EO degree: 2 to 50, alkyl radical: C₁₂-C₁₈) and ethoxylated alkylphenols (EO degree: 3 to 50, alkyl radical: C₄-C₉), of alkylsulfonic acids (alkyl radical: C₁₂-C₁₈) and of alkylarylsulfonic acids (alkyl radical: C₉-C₁₈). A preferred anionic emulsifier is sodium dodecyl sulfate. Nonionic emulsifiers which can be used are araliphatic or aliphatic nonionic emulsifiers, for example ethoxylated mono-, di- and trialkylphenols (EO degree: 3 to 50, alkyl radical: C₄-C₁₀), ethoxylates of long-chain alcohols (EO degree: 3 to 100, alkyl radical: C₈-C₃₆), and polyethylene oxide/polypropylene oxide homopolymers and copolymers. Suitable cationic emulsifiers are quaternary ammonium halides, e.g. trimethylcetylammonium chloride, methyltrioctylammonium chloride, benzyltriethylammonium chloride or quaternary compounds of N—C₆-C₂₀-alkylpyridines, -morpholines or -imidazoles. Further suitable emulsifiers can be found in Houben-Weyl, Methoden der organischen Chemie [Methods of organic chemistry], volume XIV/1, Makromolekulare Stoffe [macromolecular substances], Georg-Thieme-Verlag, Stuttgart, 1961, pp. 192-208.

The amount of emulsifier is generally about 0.01 to 10% by weight, preferably 0.1 to 5% by weight, based on the amount of monomers to be polymerized.

If desired, a seed latex can be used for the polymerization of the polymer particles forming the core.

The polymer particles forming the core preferably have an average particle size in the range from 10 to 500 nm. They are characterized by a narrow particle size distribution and a low polydispersity. They are essentially monodisperse.

In order to facilitate a joining of the polyelectrolyte side chains to the polymer particles forming the core, the polymer particles forming the core can be subjected, prior to the grafting reaction in the second stage, to a functionalization on their surface. For this, in one specific embodiment, the polymer particles forming the core can be subjected to a copolymerization with an α,β-ethylenically unsaturated photoinitiator. Suitable copolymerizable photoinitiators are described, for example, in EP 0 217 205, to which reference is hereby made.

An especially suitable α,β-ethylenically unsaturated photoinitiator is 2-[4-(2-hydroxy-2-methylpropionyl)phenoxy]ethyl methacrylate (HMEM). HMEM can be prepared by reacting methacryloyl chloride with Irgacure® 2959 (4-(2-hydroxyethoxy)phenyl (2-hydroxy-2-propyl) ketone, obtainable from Ciba Spezialitätenchemie, Switzerland) according to the process by Guo, X., Weiss, A. and Ballauf, M. in Macromolecules, 1999, 32, pp. 6043-6046.

The copolymerization of the polymer particles forming the core with an α,β-ethylenically unsaturated photoinitiator preferably takes place by adding the photoinitiator to the polymerization of the core particles toward the end of the first polymerization stage. Specifically, the copolymerization then takes place as emulsion polymerization, where the core particles already formed react like a seed latex, where the core is modified with a thin shell of the photoinitiator. Preferably, the addition of the photoinitiator takes place at a monomer conversion in the first polymerization stage of less than 99.5% by weight, specifically less than 99% by weight, based on the total weight of the monomers used in the first polymerization stage. In order to obtain core-shell particles with an advantageous morphology, the addition of the α,β-ethylenically unsaturated photoinitiator preferably takes place under “starved conditions”. For this, a slow addition rate is chosen which is preferably less than 0.5 ml/min, particularly preferably less than 0.1 ml/min.

The core particles modified with photoinitiator are then subjected in a second stage to a photoemulsion polymerization in order to graft the polyelectrolyte side chains onto the polymer particles forming the core.

Preferably, in the second stage, at least one α,β-ethylenically unsaturated monomer (M2) with a free-radically polymerizable α,β-ethylenically unsaturated double bond and at least one ionogenic and/or ionic group per molecule is used.

The ionogenic and/or ionic groups are preferably anionogenic and/or anionic groups.

Suitable monomers (M2) with a free-radically polymerizable α,β-ethylenically unsaturated double bond and at least one anionogenic and/or anionic group per molecule are ethylenically unsaturated carboxylic acids and sulfonic acids or salts thereof. The monomer (M2) is preferably selected from acrylic acid, methacrylic acid, ethacrylic acid, α-chloroacrylic acid, crotonic acid, maleic acid, maleic anhydride, itaconic acid, citraconic acid, mesaconic acid, glutaconic acid, aconitic acid, fumaric acid, the half-esters of monoethylenically unsaturated dicarboxylic acids having 4 to 10, preferably 4 to 6, carbon atoms, e.g. monomethyl maleate, vinylsulfonic acid, allylsulfonic acid, sulfoethyl acrylate, sulfoethyl methacrylate, sulfopropyl acrylate, sulfopropyl methacrylate, 2-hydroxy-3-acryloxypropylsulfonic acid, 2-hydroxy-3-methacryloxypropylsulfonic acid, styrenesulfonic acid and 2-acrylamido-2-methylpropanesulfonic acid.

Preferred monomers (M2) are acrylic acid, methacrylic acid, styrenesulfonic acids, such as styrene-4-sulfonic acid and styrene-3-sulfonic acid, and the alkaline earth metal or alkali metal salts thereof, e.g. sodium acrylate, sodium methacrylate, sodium stryene-3-sulfonate and sodium styrene-4-sulfonate. Furthermore, mixtures of these monomers are suitable. Particular preference is given to sodium styrene-4-sulfonate.

To prepare the polymer particles used according to the invention having a hydrophobic core and polyelectrolyte side chains bonded thereto, the component (M2) is preferably used in an amount of from 50 to 100% by weight, particularly preferably 80 to 100% by weight, specifically 95 to 100% by weight, based on the total weight of the monomers used in the second stage.

To prepare the polymer particles used according to the invention having a hydrophobic core and polyelectrolyte side chains bonded thereto, in the second stage, at least one monomer (M3) different from the component (M2) and copolymerizable therewith can be used. Preference is given to monomers (M3) which have a solubility in water of at least 1 g/l at 20° C.

Preference is given to monomers (M3) selected from primary amides of α,β-ethylenically unsaturated monocarboxylic acids, N-vinylamides of saturated monocarboxylic acids, N-vinyllactams, N-alkyl- and N,N-dialkylamides of α,β-ethylenically unsaturated monocarboxylic acids, esters of α,β-ethylenically unsaturated mono- and dicarboxylic acids with C₂-C₃₀-alkanediols, amides of α,β-ethylenically unsaturated mono- and dicarboxylic acids with C₂-C₃₀-amino alcohols which have a primary or secondary amino group, vinyl ethers, and mixtures thereof.

If present, the component (M3) is used preferably in an amount of from 0.1 to 50% by weight, particularly preferably 0.5 to 20% by weight, specifically 1 to 5% by weight, based on the total weight of the monomers used in the second stage. Preferably, no monomer (M3) is used.

The amount of the monomers (M2 and, if present, M3) used in the second stage for preparing the polyelectrolyte side chains is preferably 5 to 200 mol %, particularly preferably 10 to 100 mol %, based on the total amount of the monomers (M1) used in the first stage.

The polymerization in stage 2 preferably takes place by irradiation with UV light, as described, for example, by Guo, X., Weiss, A. and Ballauf, M. in Macromolecules, 1999, 32, pp 6043-6046.

In a specific embodiment, polymer particles having a hydrophobic core and polyelectrolyte side chains bonded thereto are used which are obtainable by, in a first stage, subjecting styrene to a free-radical aqueous emulsion polymerization to give a polystyrene latex, adding 2-[4-(2-hydroxy-2-methylpropionyl)phenoxy]ethyl methacrylate to the polystyrene latex and subjecting it to a further polymerization to give a polystyrene latex modified on the surface and then, in a second stage, grafting sodium styrene-4-sulfonate by photoemulsion polymerization to give poly(sodium styrene-4-sulfonate) side chains onto the polystyrene latex modified on the surface.

A specific embodiment for the preparation of a titanium dioxide composition is a process in which
a) a dispersion of polymer particles with a hydrophobic core and polyelectrolyte side chains bonded thereto in a mixture of water and at least one water-miscible organic solvent is prepared,
b) a hydrolyzable titanium compound is added to the dispersion, giving a titanium dioxide composite composition which comprises TiO₂ nanoparticles which are associated with the dispersed polymer particles.

Through the process according to the invention, specifically steps a) and b), it is possible to obtain liquid titanium dioxide composite compositions in the form of a stable suspension. For example, liquid titanium dioxide composite compositions according to the invention have no precipitate even after storage for months. In the suspension, the polymer particles with TiO₂ nanoparticles associated thereto are generally present in colloidally suspended form.

The TiO₂ nanoparticles obtained by the process according to the invention are exclusively present in the anatase modification. The modification can be determined here by X-ray diffraction (XRD) of the titanium dioxide composite particles. All of the diffraction peaks can be allocated here to the anatase modification of TiO₂ (as can be found under the Powder Diffraction File Number (PDF No.): 00-021-1272 in the ICDD database). Evidence of other crystal modifications is not found.

With regard to polymer particles having a hydrophobic core and polyelectrolyte side chains bonded thereto which are preferred and suitable for use in step a), reference is made to the previous listing in its entirety.

The dispersion provided in step a) comprises a mixture of water and at least one water-miscible organic solvent as dispersion medium (continuous phase). Suitable organic solvents are aprotic polar solvents, e.g. amides such as dimethylformamide, dimethylacetamide, or N-methylpyrrolidone, ureas, such as 1,3-dimethyl-2-imidazolidinone (DMEU) or 1,4-dimethylhexahydro-2-pyrimidinone (DMPU), ethers such as tetrahydrofuran (THF) and 1,4-dioxane, sulfolane, dimethylsulfoxide (DMSO) or nitriles such as acetonitrile or propionitrile, and mixtures of these solvents. In a preferred embodiment, the organic solvent used is an alkanol whose alkyl radical corresponds to the alkyl radicals of the tetraalkyl orthotitanate or tetraalkyl orthosilicate used for the hydrolysis. Specifically, tetraethyl orthotitanate (TEOT) is used as hydrolyzable titanium compound and ethanol is used as organic solvent.

The water content of the mixture, provided in step a), of water and at least one water-miscible organic solvent is preferably chosen such that the molar ratio of water to hydrolyzable titanium compound is in a range from 2:1 to 50:1, particularly preferably 2.1:1 to 25:1.

Surprisingly, it has been found that the particle sizes of the resulting titanium dioxide nanoparticles can be controlled via the molar ratio of water to hydrolyzable titanium compound. If, for example, TEOT is used as hydrolyzable titanium compound and if the molar ratio of water to TEOT is about 2.3:1, then titanium dioxide nanoparticles are obtained which have an average particle size, determined by means of transmission electron microscopy, of about 4 nm. If TEOT is used as hydrolyzable titanium compound and if the molar ratio of water to TEOT is about 11.5:1, then titanium dioxide nanoparticles are obtained which have an average particle size, determined by means of transmission electron microscopy, of about 12 nm.

The quantitative weight ratio of water-miscible organic solvent to water is preferably at least 10:1, particularly preferably at least 100:1, in particular at least 200:1.

As regards hydrolyzable titanium compounds which are preferred and suitable for use in step b), reference is made to the previous listing in its entirety. Particular preference is given to using tetraethyl orthotitanate (TEOT).

Preferably, the temperature in step b) is at most 60° C., particularly preferably at most 40° C. In a specific embodiment, the addition of the hydrolyzable titanium compound to the dispersion in step b) takes place at approximately ambient temperature. It is worth noting that the TiO₂ particles prepared by the process according to the invention at such low temperatures are crystalline without a heat treatment being necessary.

Surprisingly, it has been found that it is advantageous if a maximum concentration of titanium compound to be hydrolyzed in the dispersant is not exceeded over the metering time in step b). Otherwise, it may result in the formation of irregular, polydisperse titanium dioxide particles which are not embedded homogeneously in the polyelectrolyte side chains of the spherical polyelectrolyte brushes (SPB). Preferably, the metered addition of the hydrolyzable titanium compound is therefore controlled over the metering time such that essentially monodisperse spherical titanium dioxide nanoparticles are formed which are homogenously embedded in the SPB.

Preferably, the hydrolyzable titanium compound is metered at an essentially constant volume stream into the dispersion of polymer particles having a hydrophobic core and polyelectrolyte side chains bonded thereto.

Preferably, in step b) the addition of the hydrolyzable titanium compound takes place at an addition rate of at most 5%, particularly preferably of at most 2%, of the total amount of the hydrolyzable titanium compound per minute.

The titanium dioxide composite composition in liquid form obtained by the process according to the invention, specifically by steps a) and b), can additionally be subjected to a further work-up. This includes, for example, a purification and/or a drying and/or a solvent exchange. Preference is therefore given to a process comprising the aforementioned steps a) and b), where additionally
c) the titanium dioxide composite composition obtained in step b) is subjected to a purification and/or drying and/or a solvent exchange.

The purification can take place by customary methods known to the person skilled in the art. In the simplest case, for the purification, the liquid phase with impurities contained therein is separated off from the titanium dioxide composite particles. The separation can take place, for example, by sedimentation or membrane filtration. For this purpose, the centrifuges or membranes customary for this purpose and having a suitable separation limit for retaining the titanium dioxide composite particles can be used. If desired, the separated-off titanium dioxide composite particles can be subjected to a washing with a liquid washing medium. Suitable washing media are those in which the titanium dioxide composite particles do not dissolve or release the associated titanium dioxide. Preferred washing media are the water-miscible organic solvents described above and mixtures thereof with water. Particular preference is given to the washing medium selected from water and water/alkanol mixtures. In particular, a water/ethanol mixture is used as washing medium. The washing medium can in turn be separated off by sedimentation or membrane filtration.

The drying of the titanium dioxide composite composition can likewise take place in accordance with customary methods known to the person skilled in the art. If desired, before drying, the majority of the dispersion medium can be removed, for example by sedimentation or membrane filtration. Suitable drying methods are, for example, spray drying, fluidized spray drying, drum drying or freeze drying. Preferably, the drying takes place at a temperature of at most 100° C., particularly preferably of at most 80° C., in particular of at most 60° C.

The titanium dioxide composite compositions dried under the conditions described above, in particular at not excessively high temperatures, can generally be redispersed. In this connection, no or only a slight nondispersible solid generally remains. This is preferably not more than 1% by weight, based on the total weight of the solid to be redispersed. Suitable dispersion media are selected from water, the water-miscible organic solvents described above and mixtures of water with at least one of these water-miscible organic solvents. Preference is given to using water.

The invention also provides titanium dioxide composite compositions which are obtainable by the process described above. In a specific embodiment, this process comprises the above-described steps a), b) and, optionally, c). A first embodiment is titanium dioxide composite compositions in liquid form (suspension). A second embodiment is titanium dioxide composite compositions in solid form.

As polymer particles having a hydrophobic core and polyelectrolyte side chains bonded thereto, the titanium dioxide composite compositions according to the invention specifically have a polymer which comprises a polystyrene core which is modified on the surface by copolymerization with 2-[4-(2-hydroxy-2-methylpropionyl)phenoxy]ethyl methacrylate and has, grafted thereon, side chains which comprise sodium styrene-4-sulfonate in polymerized form.

Surprisingly, the suspensions according to the invention have excellent physical and chemical stability. For example, the suspensions do not sediment or coagulate upon storage for several months at room temperature. The application properties are unchanged following storage.

The solids content of the suspensions according to the invention is preferably 0.5 to 10% by weight, particularly preferably 1 to 5% by weight.

The titanium dioxide composite compositions according to the invention have a titanium dioxide content of at least 10% by weight, particularly preferably at least 15% by weight, specifically at least 18% by weight, based on the total weight in the case of solid titanium dioxide composite compositions, or the total solids content in the case of liquid titanium dioxide composite compositions. The TiO₂ content of the TiO₂ nanocomposites can be determined by means of thermogravimetric analysis (TGA).

The average particle diameter of the titanium dioxide nanoparticles present in the titanium dioxide composite compositions according to the invention (determined by means of transmission electron microscopy) is preferably in a range from 3 to 50 nm, particularly preferably from 3.5 to 40 nm, in particular from 4 to 25 nm. The particle size distribution is preferably essentially unimodal.

The titanium dioxide nanoparticles present in the titanium dioxide composite compositions according to the invention are crystalline. According to XRD, they are exclusively present in the anatase modification.

The titanium dioxide composite composition obtained by the process according to the invention, specifically steps a) and b), can, optionally after a purification, be additionally subjected to a calcination. The term calcination here refers to a thermal treatment, preferably under a controlled atmosphere.

Preference is therefore given to a process comprising the aforementioned steps a) and b), where additionally
c) the titanium dioxide composite composition obtained in step b), optionally after a purification, is subjected to a drying, and
d) the dried titanium dioxide composite composition obtained in step c) is subjected to a calcination.

As regards the purification and drying, reference is made to the previous statements relating to step c).

Typical temperature regimes for the calcination in step d) are in the range from 200 to 800° C., preferably from 250 to 700° C., particularly preferably from 300 to 600° C.

The calcination can take place under an inert atmosphere (for example nitrogen or noble gases, such as argon or helium), an oxidizing atmosphere (for example oxygen or air) or a varying atmosphere (initially inert then oxidizing atmosphere). The person skilled in the art is aware that mixtures of said gases can also be used. Thermal treatment can be carried out under a fixed or flowing atmosphere; preferably, a treatment under a flowing gas stream is carried out. A continuous introduction of fresh gas is preferred before a gas recycling. The composition of the atmosphere can be varied as a function of the calcination temperature and time. An agitated thermal treatment is also possible, for example by rotating calcination drums, shaking or fluidization. The calcination time is usually in a range from 1 minute to 24 hours, preferably 5 minutes to 12 hours.

In a first embodiment, the calcination in step d) takes place in an inert atmosphere.

In a second embodiment, the calcination in step d) takes place in an oxidizing atmosphere.

In a third embodiment, the calcination in step d) takes place in a first stage in an inert atmosphere and in a second stage in an oxidizing atmosphere.

The invention also provides the titanium dioxide compositions obtained after the calcination.

The titanium dioxide compositions obtained after the calcination in an inert atmosphere consist preferably of at least 90% by weight, particularly preferably of at least 95% by weight, in particular of at least 99% by weight, of titanium dioxide and carbon.

The titanium dioxide compositions obtained after the calcination in an oxidizing atmosphere and the titanium dioxide compositions obtained after the calcination in a first stage in an inert atmosphere and in a second stage in an oxidizing atmosphere consist preferably of at least 90% by weight, particularly preferably of at least 95% by weight, in particular of at least 99% by weight of titanium dioxide.

The titanium dioxide compositions according to the invention specifically comprise essentially no (i.e. less than 0.5% by weight, preferably less than 0.1% by weight, based on the total weight) silicon atoms and compounds containing silicon atoms.

The titanium dioxide compositions obtained after the calcination are characterized by their porous structure. For example, the polymer particles serving as template during the hydrolysis (SPB template) can be removed by calcination, which leads to a porous structure.

If the calcination takes place in an inert atmosphere (e.g. under an argon atmosphere), then the polymer is decomposed to carbon. In this way, a highly porous framework of TiO₂ is obtained, where the pore walls are coated with carbon. The invention also provides the titanium dioxide compositions in the form of a titanium dioxide composition modified with carbon and with a porous structure which are obtainable by the process described above. As a result of their large surface area coated with carbon, they are of potential interest as catalysts, e.g. for hydrogenation reactions. They furthermore serve as important intermediates for the preparation, described below, of titanium dioxide compositions with a porous structure by a subsequent calcination in an oxidizing atmosphere.

If the calcination takes place in an oxidizing atmosphere (e.g. in the presence of air) without prior calcination in an inert atmosphere, then the polymer particles serving as template are essentially completely removed. In this way, as in the case of the calcination in an inert atmosphere, a highly porous framework of TiO₂ is obtained, although the pore walls are not coated with carbon. An EDX measurement (energy dispersive X-ray) shows that the organic polymer has completely decomposed as a result of the calcination and exclusively TiO₂ is left. A comparable porous surface morphology is obtained as in the case of the exclusive calcination in an inert atmosphere. FE-SEM (field emission scanning electron microscopy) micrographs, however, show that during the calcination in an oxidizing atmosphere, a partial collapse of the pores takes place. However, this has no negative effects on the ability of the resulting titanium dioxide compositions to be used, for example, in coating compositions or for photocatalytic applications. The invention also provides the titanium dioxide compositions with a porous structure which are obtainable by the process described above.

If the calcination takes place in a first stage in an inert atmosphere (e.g. under an argon atmosphere) and in a second stage in an oxidizing atmosphere (e.g. in the presence of air), then the polymer particles serving as template are likewise essentially completely removed. In this procedure, a partial collapse of the pores, as occurs with exclusive calcination in an oxidizing atmosphere, can advantageously be avoided.

The comparison of the FE-SEM micrographs for the different heat treatments of the TiO₂ nanocomposite particles clearly shows that similarly porous surface morphologies are obtained. The titanium dioxide compositions according to the invention are characterized by a network of titanium dioxide nanoparticles with a mesoporous and macroporous structure. The titanium dioxide nanoparticles here are crystalline and are present in the anatase modification.

According to IUPAC, porous materials are defined according to their pore size as follows: microporous: pore diameter<2 nm, mesoporous: pore diameter between 2 and 50 nm and macroporous: pore diameter>50 nm.

The macropores of the titanium dioxide compositions according to the invention preferably have an average pore diameter (determined by FE-SEM (field emission scanning electron microscopy) analysis) in the range from greater than 50 to 200 nm, particularly preferably from 75 to 150 nm. The size of the macropores can be controlled via the size of the core of the polymer particles used as template.

The mesopores of the titanium dioxide compositions according to the invention preferably have an average pore diameter (determined by BET analysis) in the range from 2 to 30 nm, particularly preferably from 5 to 20 nm. The size of the mesopores can be controlled via the length and graft density of the polyelectrolyte side chains of the polymer particles used as template.

The surface area of the titanium dioxide compositions according to the invention (determined by BET analysis) is preferably at least 50 m²/g, particularly preferably at least 60 m²/g.

As a result of the calcination, the surface area of the titanium dioxide compositions according to the invention can usually be significantly increased, preferably by at least 50%, particularly preferably by at least 75%.

The titanium dioxide compositions according to the invention are characterized by very good photocatalytic activity. Thus, TiO₂, upon irradiation with UV light, can absorb photons and reacts directly with H₂O, O₂ and OH groups in order to produce reactive oxygen species. The photocatalytic activity of the titanium dioxide compositions according to the invention, either in the form of the composites, or else after the calcination, can be demonstrated, for example, by measuring the degradation of the organic dye rhodamine B (RhB) in the presence of the titanium dioxide compositions. For this, the reaction kinetics can, for example, be monitored using UV/VIS spectroscopy. Following the addition of TiO₂ nanocomposite particles, the absorption band of RhB at 552 nm decreased rapidly upon UV irradiation and had a considerable blue shift, which suggests the formation of N-diethylated intermediates during the photocatalytic decomposition of RhB.

The titanium dioxide compositions according to the invention are suitable for use as or in a catalyst with photocatalytic activity and also for producing solar cells. They are suitable specifically as component for producing coating compositions.

Titanium dioxide in the anatase modification is advantageously suitable for use in coating compositions since these have a high soiling resistance as a result of their very hydrophilic and also strongly oxidative surfaces. Photocatalytic effects of the anatase, which form free radicals under the action of UV light, atmospheric oxygen and water, are, inter alia, responsible for this. Besides the hydrophilic properties, the surfaces of coating compositions comprising anatase often also have antimicrobial properties.

Surprisingly, it has now been found that aqueous coating compositions based on the titanium dioxide compositions according to the invention lead to surface coatings with advantageous properties. These have specifically hydrophilic and/or antimicrobial and/or soiling-resistant properties and/or exhibit a reduced tendency to chalking and yellowing.

The invention therefore further provides a binder composition consisting of or comprising
an emulsion polymer of at least one α,β-ethylenically unsaturated monomer Mo) and
at least one titanium dioxide composition, as defined above.

The titanium dioxide composition can be used, if desired, in solid form, e.g. in powder form, or in liquid form, e.g. in an aqueous medium, for the preparation of a binder composition according to the invention. Titanium dioxide composition in the form of a composite composition which comprises titanium dioxide nanoparticles which are associated with polymer particles having a hydrophobic core and polyelectrolyte side chains bonded thereto are preferably used as suspension or in powder form. Calcinated titanium dioxide compositions are preferably used in powder form. The use of carbon-containing calcinated titanium dioxide compositions is not preferred.

The emulsion polymer can be prepared by free-radical aqueous emulsion polymerization according to customary methods known to the person skilled in the art.

In a suitable embodiment, the titanium dioxide composition can also be added before and/or during the emulsion polymerization for the preparation of the emulsion polymer. Preferably, the titanium dioxide composition is added to the finished emulsion polymer.

An addition after the emulsion polymerization also includes here an addition in the course of the formulation of a product which comprises an emulsion polymer based on at least one α,β-ethylenically unsaturated monomer M). For this, at least one titanium dioxide composition, as defined above, can be added as additive, for example, to a paint or to a paper coating slip.

To prepare the emulsion polymer, at least one α,β-ethylenically unsaturated monomer Mo) is used which is preferably selected from esters of α,β-ethylenically unsaturated mono- and dicarboxylic acids with C₁-C₂₀-alkanols, vinylaromatics, esters of vinyl alcohol with C₁-C₃₀-monocarboxylic acids, ethylenically unsaturated nitriles, vinyl halides, vinylidene halides, monoethylenically unsaturated carboxylic and sulfonic acids, phosphorus-containing monomers, esters of α,β-ethylenically unsaturated mono- and dicarboxylic acids with C₂-C₃₀-alkanediols, amides of α,β-ethylenically unsaturated mono- and dicarboxylic acids with C₂-C₃₀-amino alcohols which have a primary or secondary amino group, primary amides of α,β-ethylenically unsaturated monocarboxylic acids and N-alkyl and N,N-dialkyl derivatives thereof, N-vinyllactams, open-chain N-vinylamide compounds, esters of allyl alcohol with C₁-C₃₀-monocarboxylic acids, esters of α,β-ethylenically unsaturated mono- and dicarboxylic acids with amino alcohols, amides of α,β-ethylenically unsaturated mono- and dicarboxylic acids with diamines which have at least one primary or secondary amino group, N,N-diallylamines, N,N-diallyl-N-alkylamines, vinyl- and allyl-substituted nitrogen heterocycles, vinyl ethers, C₂-C₈-monoolefins, nonaromatic hydrocarbons with at least two conjugated double bonds, polyether (meth)acrylates, monomers having urea groups, and mixtures thereof.

Suitable esters of α,β-ethylenically unsaturated mono- and dicarboxylic acids with C₁-C₂₀-alkanols are methyl (meth)acrylate, methyl ethacrylate, ethyl (meth)acrylate, ethyl ethacrylate, n-propyl (meth)acrylate, isopropyl (meth)acrylate, n-butyl (meth)acrylate, sec-butyl (meth)acrylate, tert-butyl (meth)acrylate, tert-butyl ethacrylate, n-hexyl (meth)acrylate, n-heptyl (meth)acrylate, n-octyl (meth)acrylate, 1,1,3,3-tetra-methylbutyl (meth)acrylate, ethylhexyl (meth)acrylate, n-nonyl (meth)acrylate, n-decyl (meth)acrylate, n-undecyl (meth)acrylate, tridecyl (meth)acrylate, myristyl (meth)acrylate, pentadecyl (meth)acrylate, palmityl (meth)acrylate, heptadecyl (meth)acrylate, nonadecyl (meth)acrylate, arachinyl (meth)acrylate, behenyl (meth)acrylate, lignoceryl (meth)acrylate, cerotinyl (meth)acrylate, melissinyl (meth)acrylate, palmitoleinyl (meth)acrylate, oleyl (meth)acrylate, linolyl (meth)acrylate, linolenyl (meth)acrylate, stearyl (meth)acrylate, lauryl (meth)acrylate and mixtures thereof.

Preferred vinylaromatics are styrene, 2-methylstyrene, 4-methylstyrene, 2-(n-butyl)styrene, 4-(n-butyl)styrene, 4-(n-decyl)styrene and particularly preferably styrene.

Suitable esters of vinyl alcohol with C₁-C₃₀-monocarboxylic acids are, for example, vinyl formate, vinyl acetate, vinyl propionate, vinyl butyrate, vinyl laurate, vinyl stearate, vinyl propionate, versatic acid vinyl ester and mixtures thereof.

Suitable ethylenically unsaturated nitriles are acrylonitrile, methacrylonitrile and mixtures thereof.

Suitable vinyl halides and vinylidene halides are vinyl chloride, vinylidene chloride, vinyl fluoride, vinylidene fluoride and mixtures thereof.

Suitable ethylenically unsaturated carboxylic acids and sulfonic acids or derivatives thereof are acrylic acid, methacrylic acid, ethacrylic acid, α-chloroacrylic acid, crotonic acid, maleic acid, maleic anhydride, itaconic acid, citraconic acid, mesaconic acid, glutaconic acid, aconitic acid, fumaric acid, the half-esters of monoethylenically unsaturated dicarboxylic acids having 4 to 10, preferably 4 to 6, carbon atoms, e.g. monomethyl maleate, vinylsulfonic acid, allylsulfonic acid, sulfoethyl acrylate, sulfoethyl methacrylate, sulfopropyl acrylate, sulfopropyl methacrylate, 2-hydroxy-3-acryloxypropylsulfonic acid, 2-hydroxy-3-methacryloxypropylsulfonic acid, styrenesulfonic acid and 2-acrylamido-2-methylpropanesulfonic acid. For example, styrenesulfonic acids, such as styrene-4-sulfonic acid and styrene-3-sulfonic acid and the alkaline earth metal or alkali metal salts thereof, e.g. sodium styrene-3-sulfonate and sodium styrene-4-sulfonate, are preferred. Particular preference is given to acrylic acid, methacrylic acid and mixtures thereof.

Examples of phosphorus-containing monomers are, for example, vinylphosphonic acid and allylphosphonic acid. The mono- and diesters of phosphonic acid and phosphoric acid with hydroxyalkyl (meth)acrylates, specifically the monoesters, are further suitable. Also suitable are diesters of phosphonic acid and phosphoric acid which are monoesterified with a hydroxyalkyl (meth)acrylate and additionally monoesterified with an alcohol different therefrom, e.g. an alkanol. Suitable hydroxyalkyl (meth)acrylates for these esters are those specified below as separate monomers, in particular 2-hydroxyethyl (meth)acrylate, 3-hydroxypropyl (meth)acrylate, 4-hydroxybutyl (meth)acrylate, etc. Corresponding dihydrogenphosphate ester monomers include phosphoalkyl (meth)acrylates, such as 2-phosphoethyl (meth)acrylate, 2-phosphopropyl (meth)acrylate, 3-phosphopropyl (meth)acrylate, phosphobutyl (meth)acrylate and 3-phospho-2-hydroxypropyl (meth)acrylate. Also suitable are the esters of phosphonic acid and phosphoric acid with alkoxylated hydroxyalkyl (meth)acrylates, e.g. the ethylene oxide condensates of (meth)acrylates, such as H₂C═C(CH₃)COO(CH₂CH₂O)ₙP(OH)₂ and H₂C═C(CH₃)COO(CH₂CH₂O)ₙP(═O)(OH)₂, in which n is 1 to 50. Phosphoalkyl crotonates, phosphoalkyl maleates, phosphoalkyl fumarates, phosphodialkyl (meth)acrylates, phosphodialkyl crotonates and allyl phosphates are further suitable. Further suitable monomers containing phosphorus groups are described in WO 99/25780 and U.S. Pat. No. 4,733,005 to which reference is hereby made.

Suitable esters of α,β-ethylenically unsaturated mono- and dicarboxylic acids with C₂-C₃₀-alkanediols are, for example, 2-hydroxyethyl acrylate, 2-hydroxyethyl methacrylate, 2-hydroxyethyl ethacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate, 4-hydroxybutyl acrylate, 4-hydroxybutyl methacrylate, 6-hydroxyhexyl acrylate, 6-hydroxyhexyl methacrylate, 3-hydroxy-2-ethylhexyl acrylate, 3-hydroxy-2-ethylhexyl methacrylate etc.

Suitable primary amides of α,β-ethylenically unsaturated monocarboxylic acids and N-alkyl and N,N-dialkyl derivatives thereof are acrylamide, methacrylamide, N-methyl(meth)acrylamide, N-ethyl(meth)acrylamide, N-propyl(meth)acrylamide, N-(n-butyl)(meth)acrylamide, N-(tert-butyl)(meth)acrylamide, N-(n-octyl)-(meth)acrylamide, N-(1,1,3,3-tetramethylbutyl)(meth)acrylamide, N-ethylhexyl-(meth)acrylamide, N-(n-nonyl)(meth)acrylamide, N-(n-decyl)(meth)acrylamide, N-(n-undecyl)(meth)acrylamide, N-tridecyl(meth)acrylamide, N-myristyl-(meth)acrylamide, N-pentadecyl(meth)acrylamide, N-palmityl(meth)acrylamide, N-heptadecyl(meth)acrylamide, N-nonadecyl(meth)acrylamide, N-arachinyl-(meth)acrylamide, N-behenyl(meth)acrylamide, N-lignoceryl(meth)acrylamide, N-cerotinyl(meth)acrylamide, N-melissinyl(meth)acrylamide, N-palmitoleinyl-(meth)acrylamide, N-oleyl(meth)acrylamide, N-linolyl(meth)acrylamide, N-linolenyl(meth)acrylamide, N-stearyl(meth)acrylamide, N-lauryl(meth)acrylamide, N,N-dimethyl(meth)acrylamide, N,N-diethyl(meth)acrylamide, morpholinyl(meth)acrylamide.

Suitable N-vinyllactams and derivatives thereof are, for example, N-vinylpyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam etc.

Suitable open-chain N-vinylamide compounds are, for example, N-vinylformamide, N-vinyl-N-methylformamide, N-vinylacetamide, N-vinyl-N-methylacetamide, N-vinyl-N-ethylacetamide, N-vinylpropionamide, N-vinyl-N-methylpropionamide and N-vinylbutyramide.

Suitable esters of α,β-ethylenically unsaturated mono- and dicarboxylic acids with amino alcohols are N,N-dimethylaminomethyl (meth)acrylate, N,N-dimethylaminoethyl (meth)acrylate, N,N-diethylaminoethyl acrylate, N,N-dimethylaminopropyl (meth)acrylate, N,N-diethylaminopropyl (meth)acrylate and N,N-dimethylaminocyclohexyl (meth)acrylate.

Suitable amides of α,β-ethylenically unsaturated mono- and dicarboxylic acids with diamines which have at least one primary or secondary amino group are N-[2-(dimethylamino)ethyl]acrylamide, N-[2-(dimethylamino)ethyl]methacrylamide, N-[3-(dimethylamino)propyl]acrylamide, N-[3-(dimethylamino)propyl]methacrylamide, N-[4-(dimethylamino)butyl]acrylamide, N-[4-(dimethylamino)butyl]methacrylamide, N-[2-(diethylamino)ethyl]acrylamide, N-[4-(dimethylamino)cyclohexyl]acrylamide, N-[4-(dimethylamino)cyclohexyl]methacrylamide etc.

Suitable monomers Mo) are furthermore N,N-diallylamines and N,N-diallyl-N-alkylamines and acid addition salts and quaternization products thereof. Alkyl here is preferably C₁-C₂₄-alkyl. Preference is given to N,N-diallyl-N-methylamine and N,N-diallyl-N,N-dimethylammonium compounds, such as, for example, the chlorides and bromides.

Suitable monomers Mo) are furthermore vinyl- and allyl-substituted nitrogen heterocycles, such as N-vinylimidazole, N-vinyl-2-methylimidazole, vinyl- and allyl-substituted heteroaromatic compounds, such as 2- and 4-vinylpyridine, 2- and 4-allylpyridine, and the salts thereof.

Suitable C₂-C₈-monoolefins and nonaromatic hydrocarbons with at least two conjugated double bonds are, for example, ethylene, propylene, isobutylene, isoprene, butadiene, etc.

Suitable polyether (meth)acrylates are compounds of the general formula (A)

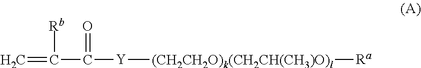

in which
the order of the alkylene oxide units is arbitrary,
k and l, independently of one another, are an integer from 0 to 100, where the sum of k and l is at least 3,
R^{a} is hydrogen, C₁-C₃₀-alkyl, C₅-C₈-cycloalkyl or C₆-C₁₄-aryl,
R^{b} is hydrogen or C₁-C₈-alkyl,
Y is O or NR^{c}, where R^{c} is hydrogen, C₁-C₃₀-alkyl or C₅-C₈-cycloalkyl.

Preferably, k is an integer from 3 to 50, in particular 4 to 25. Preferably, l is an integer from 3 to 50, in particular 4 to 25.

Preferably, R^{a} in the formula (A) is hydrogen, methyl, ethyl, n-propyl, isopropyl, n-butyl, sec-butyl, n-pentyl, n-hexyl, octyl, 2-ethylhexyl, decyl, lauryl, palmityl or stearyl.

Preferably, R^{b} is hydrogen, methyl, ethyl, n-propyl, isopropyl, n-butyl, sec-butyl, tert-butyl, n-pentyl or n-hexyl, in particular hydrogen, methyl or ethyl. R^{b} is particularly preferably hydrogen or methyl.

Preferably, Y in the formula (A) is O.

In a special embodiment, during the free-radical emulsion polymerization, at least one polyether (meth)acrylate is used. This is then preferably used in an amount up to 25% by weight, preferably up to 20% by weight, based on the total weight of the monomers Mo). 0.1 up to 20% by weight, preferably 1 to 15% by weight, of at least one polyether (meth)acrylate is particularly preferably used for the emulsion polymerization. Suitable polyether (meth)acrylates are, for example, the polycondensation products of the aforementioned α,β-ethylenically unsaturated mono- and/or dicarboxylic acids and acid chlorides, amides and anhydrides thereof with polyetherols. Suitable polyetherols can be easily prepared by reacting ethylene oxide, 1,2-propylene oxide and/or epichlorohydrin with a starter molecule such as water or a short-chain alcohol R^{a}—OH. The alkylene oxides can be used individually, alternately one after the other or as a mixture. The polyether acrylates can be used on their own or in mixtures for preparing the emulsion polymers used according to the invention.

The emulsion polymer preferably comprises at least one copolymerized polyether (meth)acrylate which is selected from the compounds of the general formulae I or II or mixtures thereof

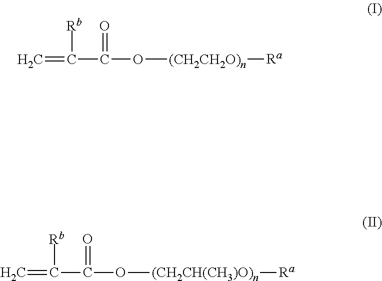

in which
n is an integer from 3 to 15, preferably 4 to 12,
R^{a} is hydrogen, C₁-C₂₀-alkyl, C₅-C₈-cycloalkyl or C₆-C₁₄-aryl,
R^{b} is hydrogen or methyl.

Suitable polyether (meth)acrylates are commercially available, e.g. in the form of various products with the name Bisomer® from Laporte Performance Chemicals, UK. These include, for example, Bisomer® MPEG 350 MA, a methoxypolyethylene glycol monomethacrylate.

According to a further preferred embodiment, no polyether (meth)acrylate is used in the free-radical emulsion polymerization for preparing the emulsion polymer.

In a further specific embodiment, at least one monomer having urea groups is used in the free-radical emulsion polymerization for preparing the emulsion polymer. Said monomer is preferably used in an amount up to 25% by weight, preferably up to 20% by weight, based on the total weight of the monomers Mo). 0.1 up to 20% by weight, in particular 1 to 15% by weight, of at least one monomer having urea groups is particularly preferably used for the emulsion polymerization. Suitable monomers having urea groups are, for example, N-vinylurea of N-allylurea or derivatives of imidazolidin-2-one. These include N-vinyl- and N-allylimidazolidin-2-one, N-vinyloxyethyl-imidazolidin-2-one, N-(2-(meth)acrylamidoethyl)imidazolidin-2-one, N-(2-(meth)-acryloxyethyl)imidazolidin-2-one (=2-ureido(meth)acrylate), N-[2-((meth)acryloxy-acetamido)ethyl]imidazolidin-2-one etc.

Preferred monomers having urea groups are N-(2-acryloxyethyl)imidazolidin-2-one and N-(2-methacryloxyethyl)imidazolidin-2-one. Particular preference is given to N-(2-methacryloxyethyl)imidazolidin-2-one (2-ureidomethacrylate, UMA).

According to a further preferred embodiment, no monomer having urea groups is used in the free-radical emulsion polymerization for the preparation of the emulsion polymer.

The aforementioned monomers Mo) can be used individually, in the form of mixtures within one monomer class or in the form of mixtures from different monomer classes.

Preferably, for the emulsion polymerization, at least 40% by weight, particularly preferably at least 60% by weight, in particular at least 80% by weight, based on the total weight of the monomers Mo), of at least one monomer Mo1) are used, said monomer being selected from esters of α,β-ethylenically unsaturated mono- and dicarboxylic acids with C₁-C₂₀-alkanols, vinylaromatics, esters of vinyl alcohol with C₁-C₃₀-monocarboxylic acids, ethylenically unsaturated nitriles, vinyl halides, vinylidene halides and mixtures thereof (main monomers). Preferably, the monomers Mo1) are used for the emulsion polymerization in an amount of up to 99.9% by weight, particularly preferably up to 99.5% by weight, in particular up to 99% by weight, based on the total weight of the monomers Mo).

The main monomers Mo1) are preferably selected from methyl (meth)acrylate, ethyl (meth)acrylate, n-propyl (meth)acrylate, isopropyl (meth)acrylate, n-butyl (meth)acrylate, sec-butyl (meth)acrylate, tert-butyl (meth)acrylate, n-pentyl (meth)acrylate, n-hexyl (meth)acrylate, n-heptyl (meth)acrylate, n-octyl (meth)acrylate, ethylhexyl (meth)acrylate, styrene, 2-methylstyrene, vinyl acetate, acrylonitrile, methacrylonitrile, butadiene and mixtures thereof.

In addition to at least one main monomer Mo1), in the free-radical emulsion polymerization for the preparation of the emulsion polymer, at least one further monomer Mo2) can be used, which is generally present to a lesser degree (secondary monomers). Preferably, for the emulsion polymerization, up to 60% by weight, particularly preferably up to 40% by weight, in particular up to 20% by weight, based on the total weight of the monomers Mo), of at least one monomer Mo2) are used, said monomer being selected from ethylenically unsaturated mono- and dicarboxylic acids and the anhydrides and half-esters of ethylenically unsaturated dicarboxylic acids, (meth)acrylamides, C₁-C₁₀-hydroxyalkyl (meth)acrylates, C₁-C₁₀-hydroxyalkyl (meth)acrylamides and mixtures thereof. Preferably, the monomers Mo2), if present, are used for the emulsion polymerization in an amount of at least 0.1% by weight, particularly preferably at least 0.5% by weight, in particular at least 1% by weight, based on the total weight of the monomers M).

For the emulsion polymerization, particular preference is given to using 0.1 up to 60% by weight, preferably 0.5 to 40% by weight, in particular 0.1 to 20% by weight, of at least one monomer Mo2). The monomers M2) are specifically selected from acrylic acid, methacrylic acid, itaconic acid, maleic acid, fumaric acid, maleic anhydride, acrylamide, methacrylamide, 2-hydroxyethyl acrylate, 2-hydroxyethyl methacrylate, 2-hydroxyethyl acrylamide, 2-hydroxyethyl methacrylamide, and mixtures thereof.

Particularly suitable monomer combinations for the process according to the invention are those listed below:
C₁-C₁₀-Alkyl (meth)acrylates and mixtures thereof, specifically
ethylhexyl acrylate, methyl methacrylate;
n-butyl acrylate, methyl methacrylate;
n-butyl acrylate, ethylhexyl acrylate;

Mixtures of at least one C₁-C₁₀-alkyl (meth)acrylate and at least one vinylaromatic, specifically
n-butyl acrylate, methyl methacrylate, styrene;
n-butyl acrylate, styrene;
n-butyl acrylate, ethylhexyl acrylate, styrene;
ethylhexyl acrylate, styrene;
ethylhexyl acrylate, methyl methacrylate, styrene;

Mixtures of at least one vinylaromatic and at least one olefin, selected from C₂-C₈-monolefins and nonaromatic hydrocarbons having at least two conjugated double bonds, specifically
styrene, butadiene.

Moreover, the aforementioned particularly suitable monomer combinations can comprise small amounts of further monomers Mo2). These are preferably selected from acrylic acid, methacrylic acid, acrylamide, methacrylamide and mixtures thereof.

In the preparation of the emulsion polymers according to the invention, in addition to the aforementioned monomers Mo), at least one crosslinker can be used. Monomers which have a crosslinking function are compounds with at least two polymerizable, ethylenically unsaturated, nonconjugated double bonds in the molecule. A crosslinking can also take place, for example, through functional groups which can enter into a chemical crosslinking reaction with functional groups complementary thereto. Here, the complementary groups can both be bonded to the emulsion polymer; for the crosslinking, a crosslinker can be used which is capable of being able to enter into a chemical crosslinking reaction with functional groups of the emulsion polymer.

Suitable crosslinkers are firstly those specified at the start for the preparation of the polymer particles with a hydrophobic core and polyelectrolyte side chains bonded thereto.

In addition, the crosslinking monomers also include those which, besides an ethylenically unsaturated double bond, have a reactive functional group, e.g. an aldehyde group, a keto group or an oxirane group, which can react with an added crosslinker. The functional groups are preferably keto or aldehyde groups. The keto or aldehyde groups are preferably bonded to the polymer through copolymerization of copolymerizable, ethylenically unsaturated compounds having keto or aldehyde groups. Suitable compounds of this type are acrolein, methacrolein, vinyl alkyl ketones having 1 to 20, preferably 1 to 10, carbon atoms in the alkyl radical, formylstyrene, (meth)acrylic acid alkyl esters having one or two keto or aldehyde groups or one aldehyde group and one keto group in the alkyl radical, where the alkyl radical preferably comprises in total 3 to 10 carbon atoms, e.g. (meth)acryloxyalkylpropanals, as are described in DE-A-2722097. Furthermore, N-oxoalkyl(meth)acrylamides, as are known, for example, from U.S. Pat. No. 4,226,007, DE-A-2061213 or DE-A-2207209, are also suitable. Particular preference is given to acetoacetyl (meth)acrylate, acetoacetoxyethyl (meth)acrylate and in particular diacetone acrylamide. The crosslinkers are preferably a compound with at least two functional groups, in particular two to five functional groups, which can enter into a crosslinking reaction with the functional groups of the polymer, specifically the keto or aldehyde groups. These include, for example, hydrazide, hydroxylamine or oxime ether or amino groups as functional groups for the crosslinking of the keto or aldehyde groups. Suitable compounds with hydrazide groups are, for example, polycarboxylic acid hydrazides having a molecular weight of up to 500 g/mol. Particularly preferred hydrazide compounds are dicarboxylic acid dihydrazides having preferably 2 to 10 carbon atoms. These include, for example, oxalic acid dihydrazide, malonic acid dihydrazide, succinic acid dihydrazide, glutaric acid dihydrazide, adipic acid dihydrazide, sebacic acid dihydrazide, maleic acid dihydrazide, fumaric acid dihydrazide, itaconic acid dihydrazide and/or isophthalic acid dihydrazide. Of particular interest are: adipic acid dihydrazide, sebacic acid dihydrazide and isophthalic acid dihydrazide. Suitable compounds with hydroxylamine or oxime ether groups are specified, for example, in WO 93/25588.

Additionally, a surface crosslinking can also be generated through a corresponding additivation of the aqueous polymer dispersion comprising the emulsion polymer. This includes, for example, addition of a photoinitiator or siccativation. Suitable photoinitiators are those which are excited by sunlight, for example benzophenone or benzophenone derivatives. Of suitability for the siccativation are the metal compounds recommended for aqueous alkyd resins, for example based on Co or Mn (overview in U. Poth, Polyester and Alkydharze [Polyesters and alkyd resins], Vincentz Network 2005, p. 183 f).

The crosslinking component is preferably used in an amount of from 0.0005 to 5% by weight, preferably 0.001 to 2.5% by weight, in particular 0.01 to 1.5% by weight, based on the total weight of the monomers used for the polymerization (including the crosslinker).

A specific embodiment relates to emulsion polymers which comprise no crosslinker in copolymerized form.

The free-radical polymerization of the monomer mixture M) can take place in the presence of at least one regulator. Regulators are preferably used in an amount of from 0.0005 to 5% by weight, particularly preferably from 0.001 to 2.5% by weight and in particular from 0.01 to 1.5% by weight, based on the total weight of the monomers used for the polymerization.

Regulators (polymerization regulators) is the term generally used to refer to compounds with high transfer constants. Regulators increase the rate of chain transfer reactions and thereby bring about a reduction in the degree of polymerization of the resulting polymers without influencing the gross reaction rate. With the regulators, a distinction can be made between mono-, bi- or polyfunctional regulators, depending on the number of functional groups in the molecule which can lead to one or more chain transfer reactions. Suitable regulators are described in detail, for example, by K. C. Berger and G. Brandrup in J. Brandrup, E. H. Immergut, Polymer Handbook, 3rd edition, John Wiley & Sons, New York, 1989, p. II/81-II/141.

Suitable regulators are, for example, aldehydes such as formaldehyde, acetaldehyde, propionaldehyde, n-butyraldehyde, isobutyraldehyde.

In addition, the following can also be used as regulators: formic acid, its salts or esters, such as ammonium formate, 2,5-diphenyl-1-hexene, hydroxylammonium sulfate, and hydroxylammonium phosphate.

Further suitable regulators are halogen compounds, e.g. alkyl halides, such as tetrachloromethane, chloroform, bromotrichloromethane, tribromomethane, allyl bromide and benzyl compounds, such as benzyl chloride or benzyl bromide.

Further suitable regulators are allyl compounds, such as, for example, allyl alcohol, functionalized alkyl ethers, such as allyl ethoxylates, alkyl allyl ethers or glycerol monoallyl ethers.

The regulators used are preferably compounds which comprise sulfur in bonded form.

Compounds of this type are, for example, inorganic hydrogensulfites, disulfites and dithioinites or organic sulfides, disulfides, polysulfides, sulfoxides and sulfones. These include di-n-butyl sulfide, di-n-octyl sulfide, diphenyl sulfide, thiodiglycol, ethylthioethanol, diisopropyldisulfide, di-n-butyl disulfide, di-n-hexyl disulfide, diacetyl disulfide, diethanol sulfide, di-t-butyl trisulfide, dimethyl sulfoxide, dialkyl sulfide, dialkyl disulfide and/or diaryl sulfide.

Suitable polymerization regulators are furthermore thiols (compounds which comprise sulfur in the form of SH groups, also referred to as mercaptans). Preferred regulators are mono-, bi- and polyfunctional mercaptans, mercapto alcohols and/or mercaptocarboxylic acids. Examples of these compounds are allyl thioglycolates, ethyl thioglycolate, cysteine, 2-mercaptoethanol, 1,3-mercaptopropanol, 3-mercaptopropane-1,2-diol, 1,4-mercaptobutanol, mercaptoacetic acid, 3-mercaptopropionic acid, mercaptosuccinic acid, thioglycerol, thioacetic acid, thiourea and alkyl mercaptans, such as n-butyl mercaptan, n-hexyl mercaptan or n-dodecyl mercaptan.

Examples of bifunctional regulators which comprise two sulfur atoms in bonded form are bifunctional thiols, such as, for example, dimercaptopropanesulfonic acid (sodium salt), dimercaptosuccinic acid, dimercapto-1-propanol, dimercaptoethane, dimercaptopropane, dimercaptobutane, dimercaptopentane, dimercaptohexane, ethylene glycol bisthioglycolates and butanediol bisthioglycolate. Examples of polyfunctional regulators are compounds which comprise more than two sulfur atoms in bonded form. Examples thereof are trifunctional and/or tetrafunctional mercaptans.

All of the specified regulators can be used individually or in combination with one another. A specific embodiment relates to polymer dispersions Pd) which are prepared by free-radical emulsion polymerization without addition of a regulator.

To prepare the polymers, the monomers can be polymerized with the help of initiators which form free radicals.

Initiators which can be used for the free-radical polymerization are the peroxo and/or azo compounds customary for this purpose, as are specified for the preparation of the polymer particles with a hydrophobic core and polyelectrolyte side chains bonded thereto, to which reference is hereby made.

Initiators which can be used are also reducing/oxidizing (=red/ox) initiator systems. The red/ox initiator systems consist of at least one mostly inorganic reducing agent and one inorganic or organic oxidizing agent. The oxidation components are, for example, the initiators already specified above for the emulsion polymerization. The reducing components are, for example, alkali metal salts of sulfurous acid, such as, for example, sodium sulfite, sodium hydrogensulfite, alkali metal salts of disulfurous acid, such as sodium disulfite, bisulfite addition compounds of aliphatic aldehydes and ketones, such as acetone bisulfite, or reducing agents such as hydroxymethanesulfinic acid and salts thereof, or ascorbic acid. The red/ox initiator systems can be used with co-use of soluble metal compounds whose metallic component can occur in several valence states. Customary red/ox initiator systems are, for example, ascorbic acid/iron(II) sulfate/sodium peroxodisulfate, tert-butyl hydroperoxide/sodium disulfite, tert-butyl hydroperoxide/Na-hydroxymethanesulfinic acid. The individual components, e.g. the reducing component, may also be mixtures, e.g. a mixture of the sodium salt of hydroxymethanesulfinic acid and sodium disulfite.

The amount of initiators is generally 0.1 to 10% by weight, preferably 0.1 to 5% by weight, based on all of the monomers to be polymerized. It is also possible to use two or more different initiators in the emulsion polymerization.

The emulsion polymers are usually prepared in the presence of at least one interface-active compound. A detailed description of suitable protective colloids can be found in Houben-Weyl, Methoden der organischen Chemie [Methods of organic chemistry], volume XIV/1, Makromolekulare Stoffe [Macromolecular substances], Georg Thieme Verlag, Stuttgart, 1961, pp. 411-420. Suitable emulsifiers can also be found in Houben-Weyl, Methoden der organischen Chemie [Methods of organic chemistry], volume 14/1, Makromolekulare Stoffe [Macromolecular substances], Georg Thieme Verlag, Stuttgart, 1961, pp. 192-208.

Suitable emulsifiers are anionic, cationic or nonionic emulsifiers. The interface-active substances used are preferably emulsifiers whose relative molecular weights are usually below those of protective colloids.

Nonionic emulsifiers which can be used are araliphatic or aliphatic nonionic emulsifiers, for example ethoxylated mono-, di- and trialkylphenols (EO degree: 3 to 50, alkyl radical: C₄-C₁₀), ethoxylates of long-chain alcohols (EO degree: 3 to 100, alkyl radical: C₈-C₃₆), and polyethylene oxide/polypropylene oxide homopolymers and copolymers. These can comprise the copolymerized alkylene oxide units in random distribution or in the form of blocks. For example, EO/PO block copolymers are highly suitable. Preference is given to using ethoxylates of long-chain alkanols (alkyl radical C₁-C₃₀, average degree of ethoxylation 5 to 100) and, of these, particular preference is given to using those with a linear C₁₂-C₂₀ alkyl radical and an average degree of ethoxylation of from 10 to 50, and also ethoxylated monoalkylphenols.

Suitable anionic emulsifiers are, for example, alkali metal and ammonium salts of alkyl sulfates (alkyl radical: C₈-C₂₂), of sulfuric acid half-esters of ethoxylated alkanols (EO degree: 2 to 50, alkyl radical: C₁₂-C₁₈) and ethoxylated alkylphenols (ED degree: 3 to 50, alkyl radical: C₄-C₉), of alkylsulfonic acids (alkyl radical: C₁₂-C₁₈) and of alkylarylsulfonic acids (alkyl radical: C₉-C₁₈). Further suitable emulsifiers can be found in Houben-Weyl, Methoden der organischen Chemie [Methods of organic chemistry], Volume XIV/1, Makromolekulare Stoffe [Macromolecular substances], Georg-Thieme-Verlag, Stuttgart, 1961, pp. 192-208). Suitable anionic emulsifiers are likewise bis(phenylsulfonic acid) ether or alkali metal or ammonium salts thereof which carry a C₄-C₂₄-alkyl group on one or both aromatic rings. These compounds are generally known, e.g. from U.S. Pat. No. 4,269,749, and are commercially available, for example as Dowfax® 2A1 (Dow Chemical Company).

Suitable cationic emulsifiers are preferably quaternary ammonium halides, e.g. trimethylcetylammonium chloride, methyltrioctyl ammonium chloride, benzyltriethyl-ammonium chloride or quaternary compounds of N—C₆-C₂₀-alkylpyridines, -morpholines or -imidazoles, e.g. N-laurylpyridinium chloride.

The amount of emulsifier is generally about 0.01 to 10% by weight, preferably 0.1 to 5% by weight, based on the amount of monomers to be polymerized.

The emulsion polymer is usually used in the form of an aqueous polymer dispersion Pd) for the preparation of the binder composition according to the invention. However, it can also be used in solid form, as is obtainable by drying an aqueous polymer dispersion Pd) according to customary methods.

Furthermore, customary auxiliaries and additives can be added to the emulsion polymers or polymer dispersions Pd). These include, for example, pH regulating substances, reducing agents and bleaches, such as, for example, the alkali metal salts of hydroxymethanesulfinic acid (e.g. Rongalit® C from BASF Aktiengesellschaft), complexing agents, deodorants, flavorings, odorants and viscosity modifiers, such as alcohols, e.g. glycerol, methanol, ethanol, tert-butanol, glycol etc. These auxiliaries and additives can be added to the polymer dispersions in the initial charge, one of the feeds or following completion of the polymerization.

The polymerization generally takes place at temperatures in a range from 0 to 150° C., preferably 20 to 100° C., particularly preferably 30 to 95° C. The polymerization preferably takes place at atmospheric pressure, although a polymerization under increased pressure, for example the autogenous pressure of the components used for the polymerization, is also possible. In one suitable embodiment, the polymerization takes place in the presence of at least one inert gas, such as, for example, nitrogen or argon.

The polymerization medium can consist either only of water or else of mixtures of water and liquids miscible therewith, such as methanol. Preference is given to using only water. The emulsion polymerization can be carried out either as a batch process or else in the form of a feed process, including stepwise or gradient procedures. Preference is given to the feed process in which some of the polymerization mixture or else a polymer seed is initially introduced into the polymerization zone, heated to the polymerization temperature, and partially polymerized, and then the remainder of the polymerization mixture is fed to the polymerization zone, usually via a plurality of spatially separated feeds, of which one or more comprise the monomers in pure or emulsified form, continuously, stepwise or with overlap of a concentration gradient while maintaining the polymerization.

The manner in which the initiator is added to the polymerization vessel in the course of the free-radical aqueous emulsion polymerization is known to the person with average skill in the art. It can either be introduced initially completely into the polymerization vessel, or can be used continuously or stepwise according to its consumption in the course of the free-radical aqueous emulsion polymerization. Specifically, this depends in a way known per se to the person with average skill in the art both on the chemical nature of the initiator system and on the polymerization temperature. Preferably, some is initially introduced and the remainder is introduced into the polymerization zone according to the consumption.

After the polymerization process, the dispersions formed during the polymerization can be subjected to a physical or chemical aftertreatment. Such processes are, for example, the known processes for reducing residual monomers, such as, for example, aftertreatment by adding polymerization initiators or mixtures of two or more polymerization initiators at suitable temperatures, aftertreatment of the polymer solution by means of steam or ammonia vapor or stripping with inert gas or treating the reaction mixture with oxidizing or reducing reagents, adsorption methods such as the adsorption of contamination on selected media, such as, for example, activated carbon or an ultrafiltration.

The resulting aqueous polymer dispersion Pd) usually has a solids content of from 20 to 70% by weight, preferably 40 to 70% by weight, particularly preferably 45 to 70% by weight and especially preferably from 45 to 65% by weight, based on the polymer dispersion.

The titanium dioxide compositions used according to the invention are characterized by good compatibility with a large number of different dispersions.

The binder compositions according to the invention can be used in aqueous coating compositions, such as, for example, paint or varnish mixtures. Suitable further polymers are, for example, film-forming polymers. These include, for example, alkyd resins. Suitable alkyd resins are, for example, water-soluble alkyd resins which preferably have a weight-average molecular weight of from 5000 to 40 000. Also suitable are alkyd resins with a weight-average molecular weight of more than 40 000, specifically of more than 100 000. An alkyd resin is understood as meaning a polyester which has been esterified with a drying oil, a fatty acid or the like (U. Poth, Polyester and Alkydharze [Polyesters and alkyd resins], Vincentz Network 2005).

Suitable water-soluble alkyd resins are alkyd resins with sufficiently high acid number, preferably in the range form 30 to 65 mg of KOH/g. Optionally, these may be present in partially or completely neutralized form. The weight-average molecular weight is preferably 8000 to 35 000 and particularly preferably 10 000 to 35 000.

The use of such further film-forming polymers, specifically alkyd resins, which increase the VOC content of the coating compositions is not preferred in certain circumstances. A specific embodiment is therefore a coating composition which has no film-forming polymer different from the emulsion polymer.

The binder compositions according to the invention are preferably used in aqueous coatings. On account of their TiO₂ content, these coatings are pigmented systems. These can have additional further pigments different from TiO₂. The fraction of pigments can be described by the pigment volume concentration (PVC). The PVC describes the ratio of the volume of pigments (V_{P}) and fillers (V_{F}) to the total volume, consisting of the volumes of binder (V_{B}), pigments and fillers of a dried coating film in percent: PVC=(V_{P}+V_{F})×100/(V_{P}+V_{F}+V_{B}). Coatings can, for example, be divided as follows by reference to the PVC:

| | |
|---|---|
| highly filled interior paint, wash-resistant, white/matt | ca. 85% |
| interior paint, rub-resistant, white/matt | ca. 80% |
| semigloss paint, satin | ca. 35% |
| semigloss paint, silk | ca. 25% |
| exterior masonry paint, white | ca. 45-55% |

The invention therefore further provides a coating in the form of an aqueous composition comprising
a binder composition, as defined above,
optionally, at least one pigment different from titanium dioxide,
optionally, at least one filler,
optionally, further auxiliaries different from pigments and fillers, and
water.

A preferred embodiment is a coating in the form of an emulsion paint.

Preference is given to a coating comprising:
10 to 60% by weight, based on the solids content, of at least one binder composition, as defined above,
10 to 70% by weight of inorganic fillers and/or inorganic pigments,
0.1 to 20% by weight of customary auxiliaries, and
water to 100% by weight.

The composition of a customary emulsion paint is described below. Emulsion paints generally comprise 30 to 75% by weight and preferably 40 to 65% by weight of nonvolatile constituents. These are understood as meaning all constituents of the preparation which are not water, but at least the total amount of binder, filler, pigment, low-volatility solvents (boiling point above 220° C.), e.g. plasticizers, and polymeric auxiliaries. Of this, approximately
a) 3 to 90% by weight, in particular 10 to 60% by weight, is the binder composition,
b) 0 to 85% by weight, preferably 5 to 60% by weight, in particular 10 to 50% by weight, is at least one further inorganic pigment,
c) 0 to 85% by weight, in particular 5 to 60% by weight, is inorganic fillers and
d) 0.1 to 40% by weight, in particular 0.5 to 20% by weight, is customary auxiliaries.

Within the context of this invention, the term pigment is used to summarize all pigments and fillers, e.g. colored pigments, white pigments and inorganic fillers. These include inorganic white pigments such as barium sulfate, zinc oxide, zinc sulfide, basic lead carbonate, antimony trioxide, lithopones (zinc sulfide+barium sulfate) or colored pigments, for example iron oxides, carbon black, graphite, zinc yellow, zinc green, ultramarine, manganese black, antimony black, manganese violet, Paris blue or Schweinfurt green. Besides the inorganic pigments, the emulsion paints according to the invention can also comprise organic colored pigments, e.g. sepia, gamboge, Cassel brown, toluidine red, para red, Hansa yellow, indigo, azo dyes, anthraquinoid and indigoid dyes, and also dioxazine, quinacridone, phthalocyanine, isoindolinone and metal complex pigments. Also suitable are synthetic white pigments with air inclusions for increasing light scattering, such as the Rhopaque® dispersions.

Suitable fillers are, for example, alumosilicates, such as feldspars, silicates, such as kaolin, talc, mica, magnesite, alkaline earth metal carbonates, such as calcium carbonate, for example in the form of calcite or chalk, magnesium carbonate, dolomite, alkaline earth metal sulfates, such as calcium sulfate, silicon dioxide etc. In coatings, finely divided fillers are naturally preferred. The fillers can be used as individual components. In practice, however, filler mixtures have proven particularly useful, e.g. calcium carbonate/kaolin, calcium carbonate/talc. Lustrous coatings generally have only small amounts of very finely divided fillers.

Finely divided fillers can also be used for increasing the coverage and/or for economizing on white pigments. To adjust the coverage of the color shade and of the color depth, mixtures of colored pigments and fillers are preferably used.

The coating according to the invention can comprise further auxiliaries.

Besides the emulsifiers used in the polymerization, customary auxiliaries include wetting agents or dispersants, such as sodium, potassium or ammonium polyphosphates, alkali metal and ammonium salts of acrylic or maleic anhydride copolymers, polyphosphonates, such as sodium 1-hydroxyethane-1,1-diphosphonate, and also naphthalenesulfonic acid salts, in particular sodium salts thereof.

Further suitable auxiliaries are flow agents, antifoams, biocides and thickeners. Suitable thickeners are, for example, associative thickeners, such as polyurethane thickeners. The amount of thickener is preferably less than 1% by weight, particularly preferably less than 0.6% by weight, of thickener, based on the solids content of the coating.

The coatings according to the invention are prepared in a known manner by mixing the components in the mixing devices customary for this purpose. It has proven useful to prepare an aqueous paste or dispersion from the pigments, water and, optionally, the auxiliaries, and only then to mix in the polymeric binder, i.e. generally the aqueous dispersion of the polymer with the pigment paste or pigment dispersion.

The coatings according to the invention generally comprise 30 to 75% by weight and preferably 40 to 65% by weight of nonvolatile constituents. These are to be understood as meaning all constituents of the preparation which are not water, but at least the total amount of binders, pigment and auxiliaries, based on the solids content of the coating. The volatile constituents are predominantly water.

Suitable coatings are also glossy coatings. The gloss of the coating can be determined in accordance with DIN 67530. For this, the coating is applied to a glass plate with a gap width of 240 μm and dried for 72 hours at room temperature. The test piece is inserted into a calibrated reflectometer and, at a defined angle of incidence, it is established to what extent the returned light has been reflected or scattered. The ascertained reflectometer value is a measure of the gloss (the higher the value, the higher the gloss).

The coating according to the invention can be applied in the customary manner to substrates, e.g. by painting, spraying, dipping, rolling, knife-coating, etc.

It is preferably used as building coating, i.e. for coating buildings or parts of buildings. In this connection, it may be mineral substrates such as renders, plaster or plasterboard, masonry or concrete, wood, woodbase materials, metal or paper, e.g. wall coverings or plastic, e.g. PVC.

The coating is preferably used for interior parts of buildings, e.g. interior walls, internal doors, paneling, banisters, furniture, etc.

The coatings according to the invention are characterized by simple handling, good processing properties and high hiding power. The coatings are low in harmful materials. They have good application properties, e.g. good water resistance, good wet adhesion, in particular also on alkyd paints, good block resistance, good overcoatability, and they exhibit good flow upon application. The equipment used can be cleaned easily using water.

Furthermore, the binder compositions according to the invention are also suitable specifically for use as binders in paper coating slips.

Emulsion polymers according to the invention for use in paper coating slips preferably comprise an emulsion polymer which comprises, in copolymerized form, at least one monomer Mo) or a monomer combination which is selected from:
C₁-C₁₀-alkyl (meth)acrylates and mixtures thereof,
mixtures of at least one C₁-C₁₀-alkyl (meth)acrylate and at least one vinylaromatic, in particular styrene,
mixtures of at least one vinylaromatic (in particular styrene) and at least one olefin which is selected from C₂-C₈-monoolefins and nonaromatic hydrocarbons having at least two conjugated double bonds (in particular butadiene).

A specific embodiment of the emulsion polymer is polybutadiene binders which comprise, in copolymerized form, butadiene and a vinylaromatic, in particular styrene, and also, optionally, at least one further monomer. The weight ratio of butadiene to vinylaromatics is, for example, 10:90 to 90:10, preferably 20:80 to 80:20.

Particular preference is given to polybutadiene binders, where the emulsion polymer consists to at least 40% by weight, preferably to at least 60% by weight, particularly preferably to at least 80% by weight, in particular to at least 90% by weight, of hydrocarbons with two double bonds, in particular butadiene, or mixtures of such hydrocarbons with vinylaromatics, in particular styrene.

A further specific embodiment of the emulsion polymer is polyacrylate binders which comprise, in copolymerized form, at least one C₁-C₁₀-alkyl (meth)acrylate or a mixture of at least one C₁-C₁₀-alkyl (meth)acrylate and at least one vinylaromatic (in particular styrene).

Besides the main monomers, the emulsion polymers present in the polybutadiene binders and the polyacrylate binders may comprise further monomers, e.g. monomers with carboxylic acid, sulfonic acid or phosphonic acid groups. Preference is given to monomers with carboxylic acid groups, e.g. acrylic acid, methacrylic acid, itaconic acid, maleic acid or fumaric acid and aconitic acid. In a preferred embodiment, the emulsion polymers comprise at least one ethylenically unsaturated acid in an amount of from 0.05% by weight to 5% by weight, based on the total weight of the monomers used, in copolymerized form.

Further monomers are, for example, also monomers comprising hydroxyl groups, in particular C₁-C₁₀-hydroxyalkyl (meth)acrylates, or amides such as (meth)acrylamide.

As constituents, paper coating slips comprise in particular
a) binder,
b) optionally a thickener,
c) optionally a fluorescent or phosphorescent dye, in particular as optical brightener,
d) pigments different from TiO₂,
e) further auxiliaries, e.g. flow auxiliaries or other dyes.

Further binders which can also be co-used are, for example, natural polymers, such as starch. The fraction of binders according to the invention is preferably at least 50% by weight, particularly preferably at least 70% by weight or 100% by weight, based on the total amount of binders.

The paper coating slips comprise binders preferably in amounts of from 1 to 50 parts by weight, particularly preferably from 5 to 20 parts by weight, of binders, based on 100 parts by weight of pigment.

Besides synthetic polymers, suitable thickeners b) are in particular celluloses, preferably carboxymethylcellulose.

The term pigment d) is understood here as meaning inorganic solids. Being pigments, these solids are responsible for the color of the paper coating slip (in particular white) and/or have merely the function of an inert filler. The pigment is generally a white pigment, e.g. barium sulfate, calcium carbonate, calcium sulfoaluminate, kaolin, talc, zinc oxide, chalk or coating clay or silicates.

The paper coating slip can be prepared by customary methods.

The paper coating slips according to the invention are highly suitable for the coating of, for example, raw paper or card. The coating and subsequent drying can take place in accordance with customary methods. The coated papers or card have good application properties, in particular they are also readily printable in known printing methods, such as flexographic, relief, gravure or offset printing. Particularly in the case of offset methods, they bring about a high picking resistance and a rapid and good color and water absorption. The papers coated with the paper coating slips can be readily used in all printing methods, in particular in the offset method.

The invention is illustrated in more detail by reference to the following nonlimiting examples.

### EXAMPLES

### I. Starting Materials and Instruments Used

Styrene was destabilized by filtration over an Al₂O₃ column and stored in the refrigerator. 2-[4-(2-Hydroxy-2-methylpropionyl)phenoxy]ethyl methacrylate (HMEM) was prepared by reacting methacryloyl chloride with Irgacure® 2959 (4-(2-hydroxyethoxy)phenyl (2-hydroxy-2-propyl) ketone, obtainable from Ciba Spezialitätenchemie, Switzerland) in accordance with the process by Guo, X., Weiss, A. and Ballauff, M., Macromolecules, 1999, 32, pp. 6043-6046. Sodium 4-styrene sulfonate is available, for example, from Aldrich.

The photoemulsion polymerization was carried out in a UV reactor (Heraeus TQ 150 Z3, wavelength range 200 to 600 nm). The low-temperature transmission electron microscopy (cryo-TEM) was carried out as described by Li, Z., Kesselman, E., Talmon, Y., Hillmyer, M. A., Lodge, T. P., Science 306, pp. 98-101, (2004). FE-SEM (field emission-scanning electron miscroscopy) was carried out on an LEO-Gemini microscope equipped with a field emission cathode. The UV spectra were recorded on a Lambda 25 spectrometer from Perkin Elmer. The X-ray diffraction experiments (XRD) were carried out at 25° C. on a Panalytical XPERT-PRO-diffractometer in the reflection mode using Cu Kα radiation.

### II. Preparation of the Composite Particles

### Example 1

### TiO₂ Nanocomposite Particles

### 1.1 Preparation of an Aqueous Dispersion of Copolymers Having Polystyrene Cores and Polyelectrolyte Side Chains

### 1.1.1 Copolymers of Polystyrene and HMEM

The copolymers of polystyrene and HMEM were prepared in accordance with processes known from the literature (Ballauff, M., Spherical polyelectrolyte brushes, Prog. Polym. Sci. 32, pp. 1135-1151 (2007).

2.07 g of sodium dodecyl sulfate in 820 ml of water and 208 g of styrene were added, with stirring, to an apparatus fitted with reflux condenser, internal thermometer and anchor stirrer. The system was then degassed several times and aerated with nitrogen. 0.44 g of potassium peroxodisulfate in 20 ml of water was then added and the mixture was heated at 80° C. for 60 min. The reaction mixture was left to cool to 70° C. and 10.64 g of HMEM (2 mol % based on styrene) dissolved in 9 ml of acetone were added dropwise. The resulting dispersion was purified by ultrafiltration with the exclusion of light.

### 1.1.2 Preparation of Polyelectrolyte Side Chains on the Polystyrene Cores

In a UV reactor, the dispersion obtained in 1.1.1 was diluted to a solids content of 2.5% with water. Then, sodium 4-styrene sulfonate (30 mol %, based on styrene) was added with stirring. The closed reactor was evacuated several times and flushed with nitrogen. The photoemulsion polymerization was started by irradiating the reactor with UV light. Irradiation was carried out for 60 minutes at room temperature (25° C.). The reaction mixture was purified by dialysis against purified water (membrane: cellulose nitrate with 100 nm pore size, Schleicher & Schuell). Then, by means of dialysis, water was exchanged for ethanol (membrane: regenerated cellulose with 200 nm pore width, Schleicher & Schuell).

### 1.2 Preparation of the TiO₂ Nanocomposite Particles

32 ml of ethanol were added to 1.09 g of polystyrene cores with polyelectrolyte side chains from 1.1.2 in ethanol (with solids content 4.62% by weight). Water was added with stirring in the amount stated in Table 1 and then a solution of 0.15 ml of tetraethyl orthotitanate (TEOT) in 8 ml of ethanol was added dropwise at a rate of 0.08 ml/min. When the reaction was complete, the reaction mixture was stirred vigorously for a further two hours. The TiO₂ alkosols were then purified three times with ethanol and water by repeated centrifugation and then redispersed in water.

TABLE 1

| Sample | PS-NaSS¹⁾ [g] | TEOT [ml] | Ethanol [ml] | Water [ml] |
|---|---|---|---|---|
| A | 1.09 | 0.15 | 40 | 0.03 |
| B | 1.09 | 0.15 | 40 | 0.15 |

¹⁾PS-NaSS: Polystyrene cores with polyelectrolyte side chains from 1.1.2 (solids fraction is 4.62% by weight)

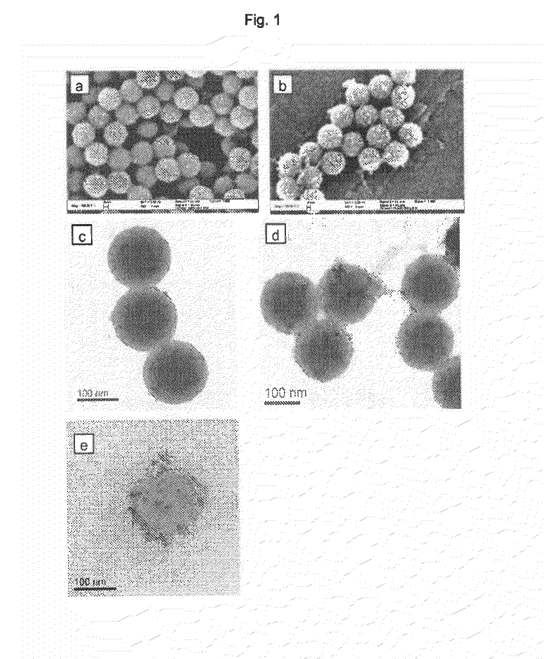

As FE-SEM micrographs on TiO₂ composite particles show, the slow controlled addition of TEOT leads to virtually monodisperse, spherical TiO₂ nanoparticles which are embedded homogeneously into the polystyrene cores with polyelectrolyte side chains (see FIG. 1a, 1b). If the volume ratio of water to TEOT during the synthesis is 1:5 (sample A), small TiO₂ nanoparticles of uniform size are formed (TEM micrograph; FIG. 1c). Moreover, an increase in the water fraction (sample B) leads to relatively large TiO₂ nanoparticles (TEM micrograph; FIG. 1d). FIG. 1e is a cryo-TEM micrograph for TiO₂ composite particles of sample B.

### Characterization of the TiO₂ Nanocomposite Particles

### Diameter:

The TiO₂ nanocomposite particles of sample A (mixture with a relatively low water fraction) have a diameter of 4±1.5 nm. The TiO₂ nanocomposite particles of sample B (mixture with a relatively high water fraction) have a diameter of 12±2 nm (determined from TEM micrograph, FIGS. 1c and 1d).

### Titanium Dioxide Content:

The TiO₂ content of the TiO₂ nanocomposites was determined by means of thermogravimetric analysis (TGA) using a Mettler-Toledo-STARe instrument. After drying the sample under reduced pressure at 30° C. overnight, the TiO₂ composite particles were heated to 800° C. at a heating rate of 10° C./min in argon or air. Thermogravimetric analysis revealed a weight fraction of 19.8% of TiO₂.

### Crystallinity:

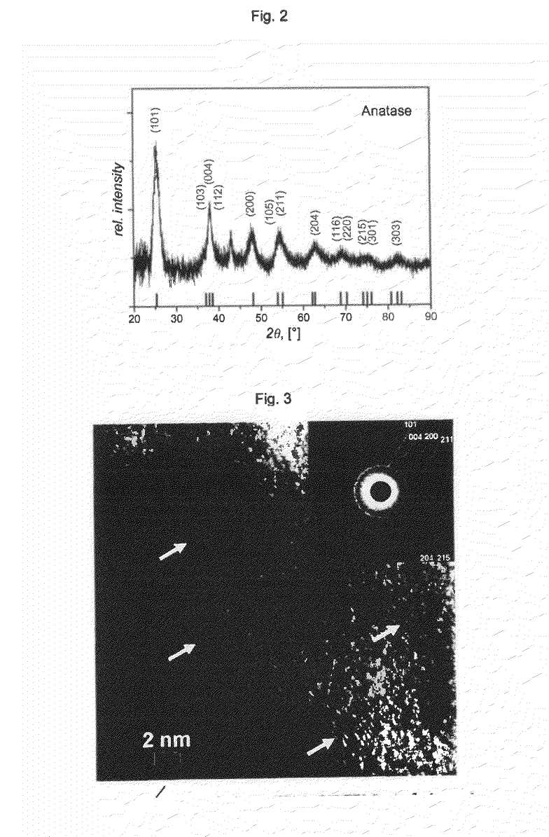

The crystallinity of the TiO₂ composite particles of sample B was investigated by X-ray diffraction (XRD) (FIG. 2). All of the diffraction peaks can be allocated to the anatase modification of TiO₂ (powder diffraction file No.: 00-021-1272). Other crystal modifications were not found. The peak at 2θ=42° originated from the polystyrene-sodium styrene sulfonate carrier particles. The crystallite size of approximately 3 nm was calculated using the Scherrer equation by analyzing the peak width during the reflection (101).

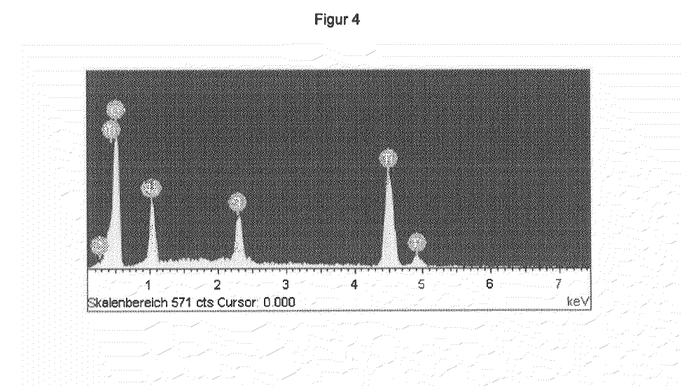

Analysis of the particles using high resolution TEM (HRTEM) and SAED confirms that crystalline anatase-TiO₂ has formed in the polystyrene cores with polyelectrolyte side chains. FIG. 3 shows an HRTEM image of the TiO₂ nanocomposite, on which the crystal lattice on the polystyrene core can be seen. Lattice rings with a lattice distance of approximately 0.35 nm refer to the (101) planes of anatase-TiO₂. Furthermore, the diffraction image (SAED, inset of FIG. 3) clearly shows the crystal structure for the anatase-TiO₂ nanocomposite. All of the diffraction rings were able to be assigned to the anatase modification, in complete agreement with the XRD experiment (see FIG. 2).

### III. Preparation of Highly Porous TiO₂

The TiO₂ nanocomposite samples obtained in 1.2 were heated at 500° C. in air in a thermolysis tube for two hours in order to decompose the polystyrene cores with polyelectrolyte side chains. Highly porous TiO₂ was obtained.

Alternatively, the TiO₂ nanocomposite samples obtained in 1.2 were heated at 500° C. in a thermolysis tube firstly under an argon atmosphere for two hours in order to decompose the polymer into carbon. Then, the carbon framework was removed by heating the material in air at 500° C. over a period of two hours. In this way, a highly porous framework of TiO₂ was obtained.

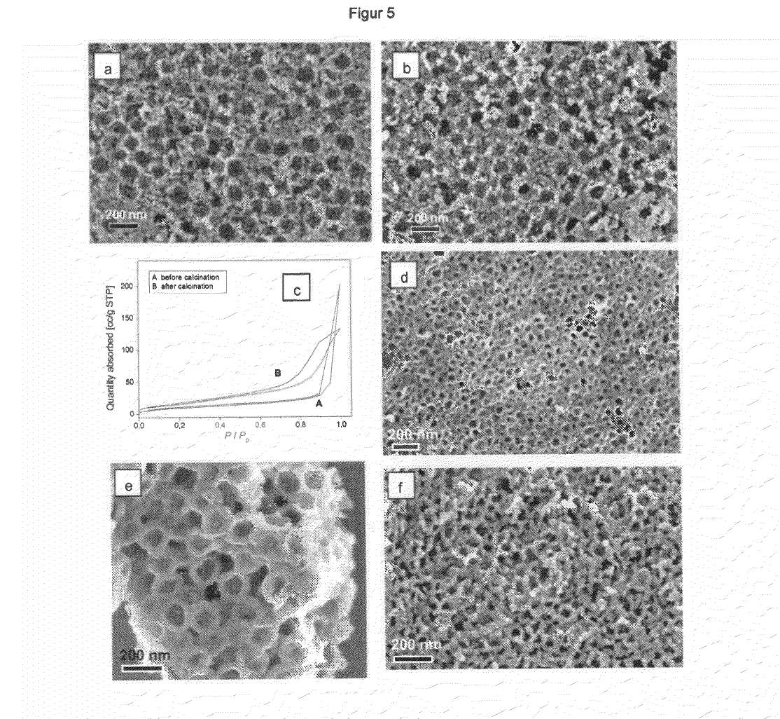

FIG. 4 is an EDX measurement for sample B after the calcination process. The EDX measurement (energy disperse X-ray) shows that the organic polymer had completely decomposed as a result of the calcination and only TiO₂ was left.

FIGS. 5a and 5b are FE-SEM micrographs of a thin layer of polystyrene cores with polyelectrolyte side chains, TiO₂ composite particles on Si wafers following calcination directly in air (a) or firstly in argon and then in air (b). FIG. 5c shows N₂ adsorption-desorption isotherms for the TiO₂ nanomaterials prepared here and calcined in air (c).

In FIG. 5a, the macropores of mesoporous TiO₂ following heat treatment can be seen. The macropores are attributed to the polystyrene core, the mesopores to the polyelectrolyte side chains. The mesopores have a diameter of 12.3 nm (calculated by BET analysis; see FIG. 5c). This is associated with an increase in the surface area from 34.61 m²/g (before calcination) to 64.25 m²/g (after calcination).

FIGS. 5d, 5e and 5f are FE-SEM micrographs of bulk samples after calcination under argon atmosphere (5d, 5e) and then in air (5f). FIGS. 5d and 5e show the formation of mesoporous structures in which carbon forms the pore walls into which TiO₂ nanoparticles are homogeneously embedded. After heating in the presence of air, white TiO₂ nanomaterials with a highly porous structure were obtained (FIG. 5f). TiO₂ nanoparticles with a diameter of ca. 12 nm can, moreover, be seen on this image.

### III. Photocatalytic Activity of the TiO₂ Composite Particle

The photocatalytic activity of the TiO₂ composite particles was analyzed by reference to the decoloring of rhodamine B (RhB) solutions.

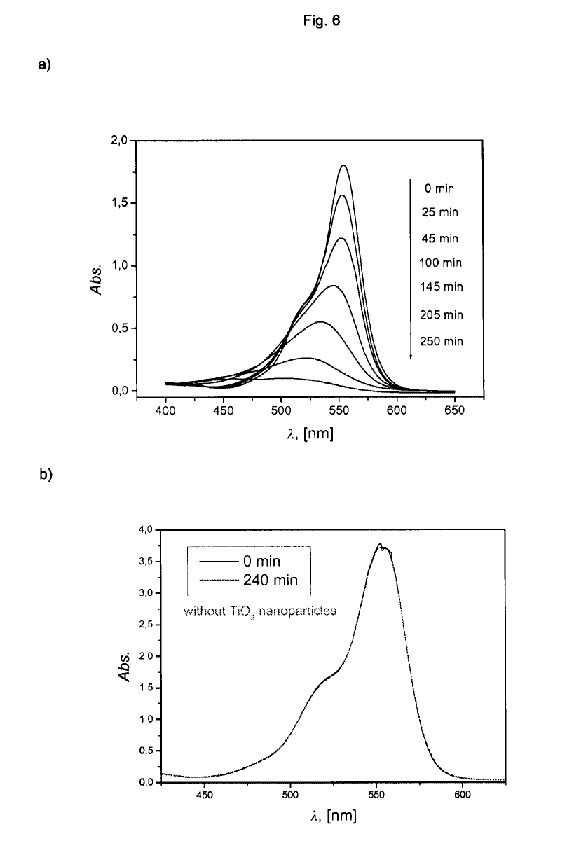

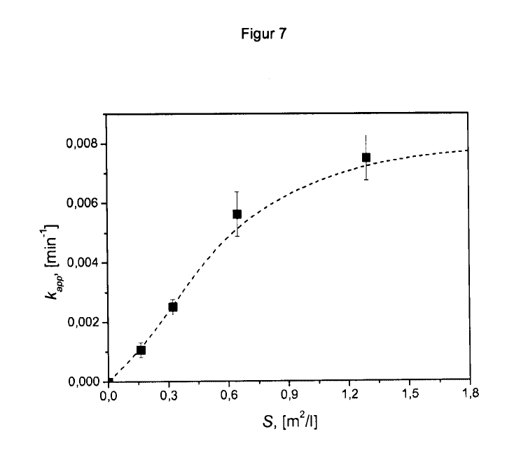

0.5 ml of a TiO₂ composite particle solution of sample B (0.2% by weight solids fraction) and 20 ml of aqueous rhodamine B (RhB) solution (c=2×10⁻⁵ mol/l) were mixed in a quartz glass cuvette with stirring. This reaction solution was stirred using a magnetic stirrer in the dark for 30 minutes prior to the irradiation in order to develop the adsorption/desorption equilibrium of the dye on the catalyst surface. UV/VIS spectra for the samples were recorded in a range from 400 to 650 nm. The rate constant of the reaction was determined by measuring the signal intensity of the peak at 552 nm with the time. For the control, rhodamine B solution without TiO₂ nanocomposite particles was irradiated under identical conditions. FIGS. 6a and 6b show UV/VIS spectra recorded for various times for the photocatalytic degradation of RhB in the presence (FIG. 6a) and the absence (FIG. 6b) of sample B during irradiation with UV light.

A reaction kinetic of first order in relation to the RhB concentration was used in order to determine the photocatalytic rate. The apparent rate constant kₐₚₚ is proportional to the total surface S of the TiO₂ nanoparticles in the system:

$$- \frac{d {c}_{t}}{d t} = {k}_{app} {c}_{t} = {k}_{1} {Sc}_{t} \qquad ( 1 )$$

Here, cₜ is the concentration of RhB at the time t, k₁ is the rate constant normalized to S, the surface area of the TiO₂ nanoparticles normalized to the unit volume of the system. For the calculation of the rate constant kₐₚₚ normalized to the surface area per unit volume in the system, the density used for anatase-TiO₂ was the value ρ=3.90×10³ kg/m³. The values for the apparent rate constant kₐₚₚ increase linearly with increasing specific surface area of the TiO₂ nanocomposite particles. FIG. 7 shows the rate constant kₐₚₚ as a function of the surface area S of sample B normalized to the unit volume of the system. The concentration of RhB was [RhB]=0.02 mmol/l at T=20° C.

Table 2 shows the photocatalytic activity of the TiO₂ nanoparticles for the degradation of RhB.

TABLE 1

| | TiO₂ | Diameter | k₁¹⁾, |
|---|---|---|---|
| Sample | particles | d, (nm) | (min⁻¹m⁻²l) |
| Sample B | Nanoparticle | 12 ± 2 | 9.41*10⁻³ |
| C1 | P25 (Degussa) | 40 ± 10 | 7.44*10⁻⁴ |
| C1 | Nanocylinders | d: 3-5 nm; | 8.41*10⁻⁵ |
| | | length: 20-40 nm | |
| C1 | Nanostrips | width: 10 nm, | 1.46*10⁻⁵ |
| | | length: 100 nm | |

C1 Comparison sample, Li, J., Ma, W., Chen, C., Zhao, J., Zhu, H., Gao,X.,
Photodegradation of dye pollutants on one-dimensional TiO₂ nanoparticles under UV and visible irradiation, J. Mol. Catal. A 261, 131-138 (2007).
¹⁾ k₁: Rate constant normalized to the surface area of the TiO₂ nanoparticles in the system (equation 1).

1. A process for preparing a titanium dioxide composition which comprises titanium dioxide nanoparticles, the processing comprising:
hydrolyzing a hydrolyzable titanium compound is in the presence of polymer particles with a hydrophobic core and polyelectrolyte side chains bonded to the hydrophobic core, to give the titanium dioxide composition comprising titanium dioxide nanoparticles.

2. The process according to claim 1, wherein the hydrolyzable titanium compound is at least one selected from the group consisting of a tetraalkyl orthotitanate and a tetraalkyl orthosilicate.

3. The process according to claim 2, wherein the hydrolyzable titanium compound is tetraethyl orthotitanate.

4. The process according to claim 1, wherein the polymer particles are obtained by
first, subjecting at least one hydrophobic α,β-ethylenically unsaturated monomer (M1) to a free-radical polymerization to give ungrafted polymer particles; and then,
second, grafting the polyelectrolyte side chains to the ungrafted polymer particles.

5. The process according to claim 4, wherein the monomer (M1) is at least one selected from the group consisting of a vinylaromatic, an ester of an α,β-ethylenically unsaturated monocarboxylic acid with a C₁-C₂₀-alkanol, an ester of an α,β-ethylenically unsaturated dicarboxylic acid with a C₁-C₂₀-alkanol, an ethylenically unsaturated nitrile, an ester of vinyl alcohol with a C₁-C₃₀-monocarboxylic acid, a vinyl halide, a vinylidene halide, a C₂-C₈-monoolefin, and a nonaromatic hydrocarbon with at least two conjugated double bonds.

6. The process according to claim 5, wherein styrene or a styrene-comprising monomer mixture is monomer (M1).

7. The process according to claim 4, wherein the ungrafted polymer particles, prior to the grafting, are subjected to a functionalization on their surface.

8. The process according to claim 7, where ungrafted the polymer particles are subjected to a copolymerization with an α,β-ethylenically unsaturated photoinitiator.

9. The process according to claim 8, wherein the α,β-ethylenically unsaturated photoinitiator is 2-[4-(2-hydroxy-2-methylpropionyl)phenoxy]ethyl methacrylate.

10. The process according to claim 4, wherein, in the grafting, at least one α,β-ethylenically unsaturated monomer (M2) with a free-radically polymerizable α,β-ethylenically unsaturated double bond and at least one ionogenic and/or ionic group per molecule is reacted.

11. The process according to claim 10, where the monomer (M2) is sodium styrene-4-sulfonate.

12. The process according to claim 1, further comprising:
a) preparing a dispersion of the polymer particles with a hydrophobic core and polyelectrolyte side chains bonded to the hydrophobic core in a mixture of water and at least one water-miscible organic solvent, giving dispersed polymer particles; and
b) adding the hydrolyzable titanium compound to the dispersion, giving a titanium dioxide composite composition comprising TiO₂ nanoparticles which are associated with the dispersed polymer particles.

13. The process according to claim 12, wherein the hydrolyzable titanium compound is at least one selected from the group consisting of a tetraalkyl orthotitanate and a tetraalkyl orthosilicate, and the organic solvent in the preparing a) is an alkanol whose alkyl radical is the same as alkyl radicals of the tetraalkyl orthotitanate or tetraalkyl orthosilicate.

14. The process according to claim 12, wherein a water content of the mixture, prepared in the preparing a), of water and at least one water-miscible organic solvent, is adjusted such that a molar ratio of water to hydrolyzable titanium compound is in a range from 2:1 to 50:1.

15. The process according to claim 12, wherein a temperature in the adding b) is at most 60° C.

16. The process according to claim 12, wherein, in b), the adding of the hydrolyzable titanium compound takes place at an addition rate of at most 5%, of a total amount of the hydrolyzable titanium compound per minute.

17. The process according to claim 12, further comprising
c) subjecting the titanium dioxide composite composition obtained in the adding b) to at least one selected from the group consisting of a purification, a drying, and a solvent exchange.

18. The process according to claim 12, further comprising:
c) drying the titanium dioxide composite composition obtained in b), optionally after a purification, to give a dried titanium oxide composite composition, and
d) calcining the dried titanium dioxide composite composition obtained in c).

19. The process according to claim 18, wherein the calcining in d) is carried out at a temperature of from 200 to 800° C.

20. The process according to claim 18, wherein the calcining in d) takes place in an inert atmosphere.

21. The process according to claim 18, wherein the calcining in d) takes place in an oxidizing atmosphere.

22. The process according to claim 18, wherein the calcining in d) takes place:
first, in an inert atmosphere; and
second, in an oxidizing atmosphere.

23. A titanium dioxide composition obtained by the process of claim 1.

24. A titanium dioxide composition obtained by the process of claim 12, in the form of a titanium dioxide composite composition which comprises titanium dioxide nanoparticles which are associated with polymer particles with a hydrophobic core and polyelectrolyte side chains bonded to the hydrophobic core.

25. A titanium dioxide composition obtained by the process of claim 18 in the form of a carbon-modified titanium dioxide composition with a porous structure.

26. The titanium dioxide composition obtained by the process of claim 21, with a porous structure.

27. The titanium dioxide composition according to claim 23, comprising a network of titanium dioxide nanoparticles with a mesoporous and macroporous structure.

28. The titanium dioxide composition according to claim 27, comprising crystalline titanium dioxide nanoparticles in an anatase modification.

29. The titanium dioxide composition according to claim 23, comprising macropores with an average pore diameter, determined by FE-SEM analysis, in a range from greater than 50 to 200 nm.

30. The titanium dioxide composition claim 23, comprising mesopores with an average pore diameter, determined by BET analysis, in a range from 2 to 30 nm.

31. The titanium dioxide composition according to claim 23, wherein a surface area of the titanium dioxide composition, determined by BET analysis, is at least 50 m²/g.

32. A binder composition comprising:
an emulsion polymer of at least one α,β-ethylenically unsaturated monomer Mo); and
at least one titanium dioxide composition, as defined in claim 23.

33. The binder composition according to claim 32, wherein the emulsion polymer is obtained by free-radical emulsion polymerization of at least one α,β-ethylenically unsaturated monomer Mo) which is at least one selected from the group consisting of an ester of an α,β-ethylenically unsaturated monocarboxylic acid with a C₁-C₂₀-alkanol, an ester of an α,β-ethylenically unsaturated dicarboxylic acid with a C₁-C₂₀-alkanol, a vinylaromatic, an ester of vinyl alcohol with a C₁-C₃₀-monocarboxylic acid, an ethylenically unsaturated nitrile, a vinyl halide, a vinylidene halide, a monoethylenically unsaturated carboxylic acid, a monoethylenically unsaturated sulfonic acid, a phosphorus-comprising monomer, an ester of an α,β-ethylenically unsaturated monocarboxylic acid with a C₂-C₃₀-alkanediol, an ester of an α,β-ethylenically unsaturated dicarboxylic acid with a C₂-C₃₀-alkanediol, an amide of an α,β-ethylenically unsaturated monocarboxylic acid with a C₂-C₃₀-amino alcohol which has a primary amino group, an amide of an α,β-ethylenically unsaturated monocarboxylic acid with a C₂-C₃₀-amino alcohol which has a secondary amino group, an amide of an α,β-ethylenically unsaturated dicarboxylic acid with a C₂-C₃₀-amino alcohol which has a primary amino group, an amide of an α,β-ethylenically unsaturated dicarboxylic acid with a C₂-C₃₀-amino alcohol which has a secondary amino group, a primary amide of an α,β-ethylenically unsaturated monocarboxylic acid an N-alkyl amide of an α,β-ethylenically unsaturated monocarboxylic acid, an N,N-dialkyl amide of an α,β-ethylenically unsaturated monocarboxylic acid, an N-vinyllactam, an open-chain N-vinylamide compound, an ester of allyl alcohol with a C₁-C₃₀-monocarboxylic acid, an ester of an α,β-ethylenically unsaturated monocarboxylic acid with an amino alcohol, an ester of an α,β-ethylenically unsaturated dicarboxylic acid with an amino alcohol, an amide of an α,β-ethylenically unsaturated monocarboxylic acid with a diamine which has at least one primary amino group, an amide of an α,β-ethylenically unsaturated monocarboxylic acid with a diamine which has at least one secondary amino group, an amide of an α,β-ethylenically unsaturated dicarboxylic acid with a diamine which has at least one primary amino group, an amide of an α,β-ethylenically unsaturated dicarboxylic acid with a diamine which has at least one secondary amino group, an N,N-diallylamine, an N,N-diallyl-N-alkylamine, a vinyl-substituted nitrogen heterocycle, an allyl-substituted nitrogen heterocycle, a vinyl ether, a C₂-C₈-monoolefin, a nonaromatic hydrocarbon with at least two conjugated double bonds, a polyether (meth)acrylate, and a monomer having at least one urea group.

34. The binder composition according to claim 32, wherein, for the emulsion polymerization, at least 40% by weight, of at least one monomer Mo1) is polymerized, said monomer Mo1) being at least one selected from the group consisting of an ester of an α,β-ethylenically unsaturated monocarboxylic acid with a C₁-C₂₀-alkanol, an ester of an α,β-ethylenically unsaturated dicarboxylic acid with a C₁-C₂₀-alkanol, a vinylaromatic, an ester of vinyl alcohol with a C₁-C₃₀-monocarboxylic acid, an ethylenically unsaturated nitrile, a vinyl halide, and a vinylidene halide.

35. The binder composition according to claim 34, wherein, additionally, for the emulsion polymerization, up to 60% by weight of at least one monomer Mo2) is polymerized, said monomer Mo2) being selected at least one from the group consisting of an ethylenically unsaturated monocarboxylic acid, an ethylenically unsaturated dicarboxylic acid, an anhydride of an ethylenically unsaturated dicarboxylic acid, a half-ester of an ethylenically unsaturated dicarboxylic acid, a (meth)acrylamide, a C₁-C₁₀-hydroxyalkyl (meth)acrylate, and a C₁-C₁₀-hydroxyalkyl (meth)acrylamide.

36. A coating, comprising:
the binder composition of claim 32;
optionally, at least one pigment different from titanium dioxide;
optionally, at least one filler;
optionally, at least one further auxiliary; and
water.

37. The coating according to claim 36 in the form of an emulsion paint.

38. A method of coating a substrate, the method comprising contacting the coating according to claim 36 with the substrate.

39. A method of producing a coated substrate, the method comprising:
applying the coating according to claim 36 to a substrate, to give a preliminarily coated substrate; and
drying the preliminarily coated substrate under conditions under which the polymer forms a film, to give the coated substrate.

40. The method according to claim 39, wherein the substrate is a plastic, metal, wood, paper, or mineral substrate.

41. A coated substrate obtained by the method according to claim 40.

42. A paper coating slip comprising the binder composition of claim 32.

43. A catalyst, comprising the titanium dioxide composition of claim 23, wherein said catalyst has photocatalytic activity.

44. A solar cell, comprising the titanium dioxide composition of claim 23.
